(19) United States
(12) Patent Application Publication
(10) Pub. No.: US 2025/0004536 A1
(43) Pub. Date: Jan. 2, 2025

(54) DEVICE, SYSTEM, AND METHOD FOR PROVIDING ISOLATION BETWEEN CORES TO FACILITATE A MULTI-TENANT ENVIRONMENT

(71) Applicant: Intel Corporation, Santa Clara, CA (US)

(72) Inventors: Adwait Purandare, Beaverton, OR (US); Ankush Varma, Portland, OR (US); Nilanjan Palit, Northborough, MA (US); Yuval Bustan, Moshav Mismeret (IL); Eran Barnett, Haifa (IL); Eliezer Weissman, Haifa (IL); Stanley Chen, Portland, OR (US); Arjan Van De Ven, Portland, OR (US)

(73) Assignee: Intel Corporation, Santa Clara, CA (US)

(21) Appl. No.: 18/216,456

(22) Filed: Jun. 29, 2023

(51) Int. Cl. G06F 1/3296; G06F 1/324

(52) U.S. Cl. CPC G06F 1/3296; G06F 1/324

(57) ABSTRACT

Techniques and mechanisms for determining operation a processor core which is in a common power delivery domain with one or more other processor cores. In an embodiment, an execution of instructions by a first core of a processor module is selectively throttled based on the detection of a single violation condition. The throttling is performed while the cores of the processor module are each maintained in a current power state. The single violation condition comprises a violation of a test criteria by the first core, while the one or more other cores of the module each satisfy the test criteria. In the case of a multiple violation condition, each core of the processor module is transitioned from one power state to another power state. In another embodiment, the test criteria includes or is otherwise based on a threshold level of a dynamic capacitance for a given core.

### BACKGROUND

### 1. Technical Field

This disclosure generally relates to processor operations and more particularly, but not exclusively, to power management of a multi-core processor.

### 2. Background Art

As power requirements for computing systems have grown, power management for energy conservation remains a challenge. Currently, some processors variously operate under a fixed dynamic capacitance threshold which is usually the maximum dynamic capacitance (CdynMax) needed for enough power delivery to handle any expected workload at the fastest available operational frequency (and thus higher power). CdynMax directly impacts multiple parameters in a computer system. CydnMax is one parameter which is usually used to define processor power delivery system and provides the guard band in designing various circuits and performance metrics. For example, CydnMax often dictates the power supply regulation specifications (e.g., output voltage level and current), power gate sizing, voltage regulator maximum current, voltage regulator maximum current, quality and reliability guard bands, IR drop, di/dt droop, and maximum operating frequency POnMax.

Various processor architectures are capable of supporting several different instruction sets. Some instruction sets—such as various Advanced Vector Extensions to the x86 instruction set by Intel Corporation—support relatively large vector (or other) operations, and can provide significant performance improvement. These more complex instruction sets tend to be associated with relatively high dynamic capacitance (Cdyn), which contributes to significant power and/or current excursions in system operations.

In existing processor module architectures, wherein cores of a given processor module share a common power delivery, a workload running on one core of a module can impact the frequency and/or supply voltage of another core of that same module. Such an impact often leads to unwanted performance variation between cores of the same module. As successive generations of processor architectures continue to operate under increasingly strict power and performance constraints, there is expected to be an increasing premium placed on improvements to how power management is provided for cores of a multi-core processor.

### BRIEF DESCRIPTION OF THE DRAWINGS

The various embodiments of the present invention are illustrated by way of example, and not by way of limitation, in the figures of the accompanying drawings and in which:

FIG. 1 shows a functional block diagram illustrating features of a system to selectively throttle one of multiple cores of a processor module according to an embodiment.

FIG. 2 shows a functional block diagram illustrating features of a processor to provide power management of multiple cores according to an embodiment.

FIGS. 3A, 3B show flow diagrams each illustrating features of a respective method to determine an operation of a processor module according to a corresponding embodiment.

FIG. 4 shows a graph illustrating operational characteristics of a processor module according to an embodiment.

FIG. 5 shows a timing diagram illustrating operational characteristics of a processor module according to an embodiment.

FIG. 6 shows a functional block diagram illustrating features of a computing device to manage power consumption of a processor module according to an embodiment.

FIG. 7 illustrates an exemplary system.

FIG. 8 illustrates a block diagram of an example processor that may have more than one core and an integrated memory controller.

FIG. 9A is a block diagram illustrating both an exemplary in-order pipeline and an exemplary register renaming, out-of-order issue/execution pipeline according to examples.

FIG. 9B is a block diagram illustrating both an exemplary example of an in-order architecture core and an exemplary register renaming, out-of-order issue/execution architecture core to be included in a processor according to examples.

FIG. 10 illustrates examples of execution unit(s) circuitry.

### DETAILED DESCRIPTION

Embodiments discussed herein variously provide techniques and mechanisms for determining operation a processor core (or “core” herein) which shares a power state with one or more other processor cores. Some embodiments variously prevent or otherwise mitigate performance variation—e.g., including frequency variation—between cores of a given processor module, wherein the cores of said module share a common power delivery. For example, such variation is due to cores executing instructions of different respective instruction sets and/or running heterogenous types of workloads. In various embodiments, the execution of at least one instruction sequence by one core of a module is selectively throttled—e.g., while one or more other cores of the module are protected from such throttling—to mitigate an increase to a dynamic capacitance (Cdyn). The selective throttling enables deterministic performance characteristics—e.g., deterministic frequency characteristics—which, for example, facilitate compliance with critical key performance indicators (KPIs) such as those defined by cloud service providers (CSPs). For example, such selective throttling facilitates a performance isolation between different cores of a processor module (e.g., across different tenants' virtual machines which are executed with said cores) and, in some embodiment, between cores of different respective modules.

By contrast, legacy voltage-frequency (VF) management techniques induce or otherwise allow a difference between the respective performance characteristics currently being exhibited by an “aggressor” (relatively high Cdyn) core of a module, and one or more “victim” (relatively low Cdyn) cores of that same module. Currently, in some typical use cases, a frequency variation can be up to 500-700 MHz, which is a major problem in cloud virtual machine (VM) deployments where customers pay based on performance guarantees. The frequency variation of such a degree makes it extremely difficult for CSPs to provide performance guarantees. To mitigate such difficulties, some embodiments selectively control Cdyn at a core level of granularity within a processor module, which enables the module as a whole to run at a deterministic frequency, even under performance variation limits which (for example) are provided by software.

In various embodiments, circuitry and/or other logic provides functionality to determine whether one processor core of a processor module is to be throttled—e.g., in lieu of transitioning two or more cores (e.g., all cores) of that same processor module from a current power state to an alternative power state. As used herein, the term “processor module” (or, for brevity, simply a “module”) refers to a set of processing resources of a given processor, wherein the resources comprise a plurality of processor cores which are configured to operate in a common power delivery domain. For example, the cores of a given module are each coupled to receive the same supply voltage and/or are each coupled to receive the same clock signal. Accordingly, a power state of one of the module's cores is to be the same as, or otherwise determines at least in part, the power state of each other of the module's cores. In some embodiments, a processor module further comprises one or more caches and/or any of various other hardware resources which, for example, are shared by cores of said processor module.

In various embodiments, a given processor comprises two or more modules which each comprise a respective plurality of cores, wherein power management of the cores of one such module is, in one or more respects, independent of power management of the respective cores of another (e.g., each other) module of that processor. In one such embodiment, a computer device or other such platform comprises multiple processors, some or all of which each comprise a respective multiple processor modules.

In some embodiments, a processor module comprises a first core, an operational characteristic of which—such as a dynamic capacitance (Cdyn)—is a basis for logic to select between multiple power management options. In one such embodiment, the power management options include throttling an execution of instructions with the first core, performing a power state transition for all cores of the module, and/or forgoing any such throttling or power state transition. The power management logic comprises hardware, firmware, executing software and/or any of various suitable combinations thereof, in various embodiments. In an embodiment, the throttling option is selected to reduce or otherwise mitigate an increase to the Cdyn characteristics of the throttled core. For example, an instruction sequence which exhibits relatively high Cdyn characteristics is throttled at one core, while another instruction sequence which exhibits relatively low Cdyn characteristics (e.g., at another core) is protected from such throttling.

In some embodiments, cores of a given processor module are configured to be operated, at various times, in any of multiple power states which each correspond to a different respective amount of power consumption by the cores of the module. For example, some or all such power states each include, or otherwise correspond to, a different respective level of a supply voltage which is provided to two or more cores (e.g., each core) of the module—e.g., wherein a level of the supply voltage is changed to facilitate a change of the module's cores between two such power states. Additionally or alternatively, some or all such power states each include, or otherwise correspond to, a different respective frequency of a clock signal which is provided to multiple cores (e.g., each core) of the module—e.g., wherein a frequency of the clock signal is changed to facilitate a change of the module's cores between two such power states. Additionally or alternatively, some or all such power states each include, or otherwise correspond to, a different respective combination of one or more functional blocks of a given core each being in a respective active state, and one or more other functional blocks of the given core each being in a respective inactive state. Some or all such power states are adapted (for example) from power states which are used in any of various existing processor architectures, in various embodiments. However, some embodiments are not limited with respect to a particular plurality of power states which are available to be configured at different times.

Certain features of various embodiments are described herein with reference to the selection of a power management option based on an operational characteristic which includes, or otherwise corresponds to, a dynamic capacitance of a given processor core. For example, some embodiments select between options—e.g., comprising a core throttling option, a power state transition option, and/or an option to forego any such throttling or power state transitioning—based on a total number of module cores, if any, for which a threshold Cdyn level is exceeded (or is expected to be exceeded). However, some embodiments variously select between such power management options based on any of various additional or alternative operational characteristics of one or more processor cores.

In an embodiment, power management logic of a processor module (or alternatively, power management logic which is external to said module) is configured to receive, generate or otherwise identify a performance constraint which includes, or is otherwise indicative of, one or more threshold levels of a Cdyn (or other suitable operational characteristic). For example, power management logic of the module is coupled to receive an indication of such a performance constraint from a power control unit (p-unit) which is external to the module. By way of illustration and not limitation, the performance constraint comprises a frequency variability limit, such as a permissible amount of deviation by the module's cores from some target (or “baseline”) frequency. In one such embodiment, the power management logic identifies one or more threshold Cdyn levels based on the power constraint—e.g., wherein multiple possible power states of the module each correspond to a respective one or more such threshold Cdyn levels.

In an illustrative scenario according to one embodiment, power management logic of a processor module performs, or otherwise operates based on, a monitoring of the execution of various instructions each by a respective one of that module's cores. For example, this monitoring comprises detecting, for a given one such core, whether a Cdyn of the core has exceeded—or, for example, is expected to exceed (according to some predetermined criteria)—a threshold Cdyn level which corresponds to a currently configured power state of the module's cores. In one such embodiment, cores of the module each comprise respective power management logic to perform local Cdyn monitoring at that core—e.g., wherein the module further comprises other power management logic (e.g., a local p-unit, for example) which is configured to collect monitoring information from the respective power management logic of the various cores.

In one such embodiment, such monitoring of a given core includes, or is otherwise based on, power management logic performing an averaging operation, an integration operation, and/or any of various other suitable calculations, based on a Cdyn value (or another performance metric which indicates a Cdyn value), to generate a value which is subsequently compared to (or otherwise evaluated based on) a corresponding threshold Cdyn value.

Alternatively or in addition, such monitoring comprises receiving or otherwise detecting information which identifies, for each of one or more instructions which are to be executed with a given core, a respective instruction type of that instruction. In one such embodiment, power management logic includes, or otherwise has access to, reference information which specifies relationships of multiple instruction types each with a different respective Cdyn level (for example, with different respective range of Cdyn levels). For example, the reference information comprises a lookup table, a function and/or any of various other suitable types of information which identify a correspondence of instruction types each with a different respective Cdyn level. The power management logic (or other suitable logic) performs any of various look-ups, calculations, or other suitable operations to determine an estimated (or actual) Cdyn level—e.g., including a moving average Cdyn level-based on the reference information and the identified type(s) of one or more instruction executed with the given core.

In various embodiments, power management logic evaluates a Cdyn value for a first core of a given module—e.g., the evaluating based on a current test criteria including a threshold Cdyn level which corresponds to a current power state of the core—to determine, at least in part, whether the first core is to be throttled or whether, alternatively, all cores of the module are to be transitioned to another power state. In one such embodiment, throttling of a core is performed based on the identification of an instance of a condition (referred to herein as a “single violation condition”) wherein one core violates, or is expected to violate, the current test criteria while each other core of the same module satisfies the current test criteria. By contrast, in some embodiments, multiple cores—e.g., all cores—of the module are to be transitioned to another power state based on the identification of an instance of another condition (referred to herein as a “multiple violation condition”) wherein two or more cores of the module each violate, or are expected to violate, the current test criteria. It is to be noted that various instances of a single violation condition can differ, for example, with respect to which core violates a current test criteria, and/or with respect to which test criteria is the current test criteria which is violated. Similarly, various instances of a multiple violation condition can differ, for example, with respect to which cores violate a current test criteria, and/or with respect to which test criteria is the current test criteria which is violated.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including circuitry which supports a provisioning of power management functionality for a multi-core module (e.g., one of multiple modules) of a processor.

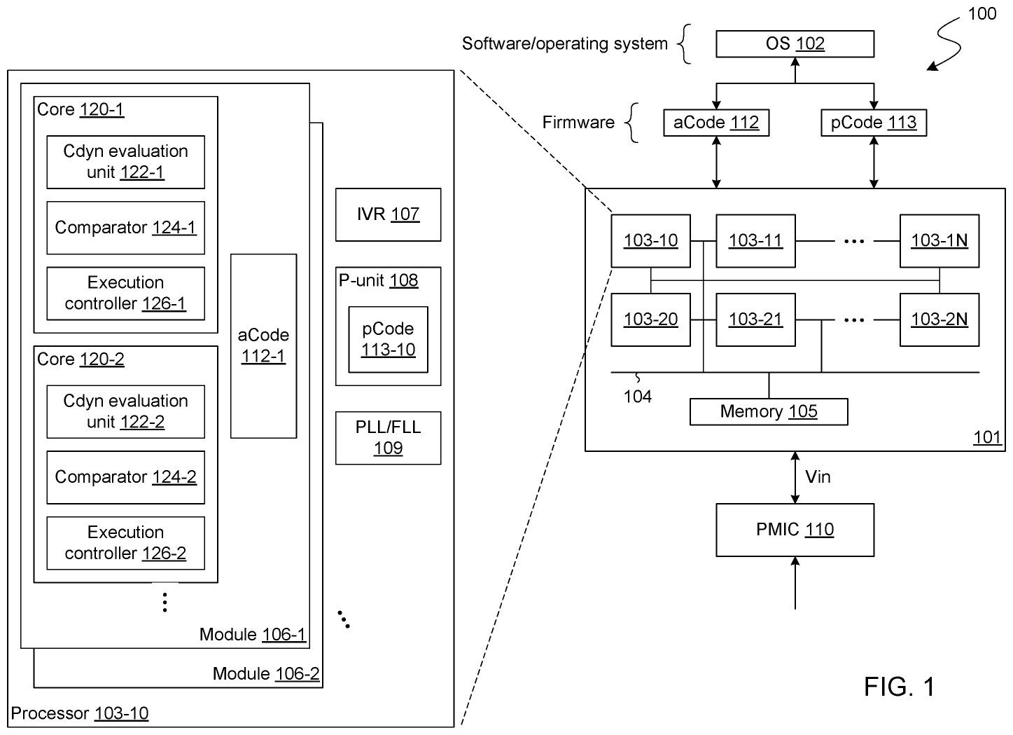

FIG. 1 shows a system 100 which provides functionality to selectively throttle one of two or more cores of a processor module according to an embodiment. System 100 illustrates features of one example embodiment wherein a performance constraint (such as one which includes, is based on, or otherwise corresponds to a threshold level of a dynamic capacitance) is a criteria for evaluating the respective performances of multiple cores of a processor module. In one such embodiment, throttling of one such core is performed where a single violation condition is detected. Additionally or alternatively, no such throttling is performed where a multiple violation condition is detected—e.g., wherein, instead, the cores are each subjected to a respective power state transition.

System 100 comprises processor hardware 101 which is coupled to provide, or otherwise operate with, an operating system (OS) 102. Some embodiments provide an interface between OS 102 and processor hardware 101—e.g., with one or more mode set registers (MSRs), with memory mapped input output (MMIO) mechanisms, or the like. For example, some embodiments provide a software interface through which a virtual machine orchestration layer, a hypervisor, or other authorized software agent is able to define a bound on an acceptable variability (including no variability, for example) to a frequency of a processor core. For example, such an interface enables a CSP to enforce performance constraints according to the terms of a service level agreement (SLA), wherein power management hardware of a processor module configures itself to implement said performance constraints. By way of illustration and not limitation, the interface includes, or is exposed by, or otherwise operates based on one or more mode set registers (MSRs), one or more designated vendor-specific extended capabilities (DVSEC) interfaces, or the like.

In one such embodiment, a frequency variability bound is programmed via a software interface on a per-module level of granularity. Accordingly, a CSP (or other such agency) is able to mix different types of software instances—e.g., for different respective tenants—in the same system on chip (SoC). For example, the CSP is able to program various frequency variability bounds, for different modules, each based on respective SLA. In one such embodiment, a Punit in the SoC translates a defined frequency variability bound into a Cdyn ceiling—e.g., a per core Cdyn ceiling—and sends it to a processor module which is to selectively throttle instruction execution, on a core-specific basis, based on the Cdyn ceiling.

Processor hardware 101 comprises one or more processors 103 (in the example embodiment shown, the individually labeled processors 103_10 through 103_1N, and 103_20 through 103_2N, where ‘N’ is a number), a fabric 104 connecting the processor 103, and a memory 105. In some embodiments, a given processor 103 is a die, dielet, or chiplet. Here the term “die” generally refers to a single continuous piece of semiconductor material (e.g. silicon) which have variously formed therein or thereon transistors and/or other components which, for example, make up multiple processor cores. In some embodiments, a given multi-core processor has two or more processors on a single die or, alternatively, the two or more processors are provided on two or more respective dies. In some embodiments, each processor module (and/or each processor die, for example) has a dedicated power controller or power control unit (p-unit) power controller or power control unit (p-unit) which can be dynamically or statically configured as a supervisor or supervisee. In some examples, dies are of the same size and functionality i.e., wherein said dies comprise symmetric cores. However, dies can also be asymmetric. For example, some dies have different size and/or function than other dies. In some embodiments, a given processor 103 is a dielet or chiplet. Here the term “dielet” or “chiplet” generally refers to a physically distinct semiconductor die, typically connected to an adjacent die in a way that allows the fabric across a die boundary to function like a single fabric rather than as two distinct fabrics. Thus at least some dies are dielets, in various embodiments. For example, a given dielet includes one or more p-units which can be dynamically or statically configured as a supervisor, supervisee or both.

In some embodiments, fabric 104 is a collection of interconnects or a single interconnect that allows the various dies to communicate with one another. Here the term “fabric” generally refers to communication mechanism having a known set of sources, destinations, routing rules, topology and other properties. The sources and destinations may be any type of data handling functional unit such as power management units. Fabrics can be two-dimensional spanning along an x-y plane of a die and/or three-dimensional (3D) spanning along an x-y-z plane of a stack of vertical and horizontally positioned dies. A single fabric spans multiple dies, in some embodiments. A fabric can take any of various suitable topologies such as a mesh topology, star topology, daisy chain topology, or the like. A fabric is part of a network-on-chip (NoC) with multiple agents, in some embodiments. These agents can be any of various suitable functional units.

In some embodiments, some or all of the one or more processor 103 each includes a respective one or more processor modules which each comprises a plurality of processor cores. One such example is illustrated with reference to processor 103_10. In this example, processor 103_10 includes a plurality of modules 106-1 through 106-M, where M is a positive integer. For the sake of simplicity, a processor module is referred by the general label 106. In this example, module 106-1 includes at least cores 120-1 and 120-2. For the sake of simplicity, a core of module 106-1 is referred by the general label 120.

Here, the term “processor core” generally refers to an independent execution unit that can run one program thread at a time in parallel with other cores. In some embodiments, a given processor core includes a dedicated power controller or power control unit (p-unit) which can be dynamically or statically configured as a supervisor or supervisee. This dedicated p-unit is also referred to as an autonomous p-unit, in some examples. In some examples, all processor cores are of the same size and functionality i.e., symmetric cores. However, processor cores can also be asymmetric. For example, some processor cores have different size and/or function than other processor cores. A processor core can be a virtual processor core or a physical processor core. Processor 103_10 includes an integrated voltage regulator (IVR) 107, power control unit (p-unit) 108, phase locked loop (PLL) and/or frequency locked loop (FLL) 109. The various blocks of processor 103_10 are coupled via an interface or fabric. Here, the term “interconnect” refers to a communication link, or channel, between two or more points or nodes. It comprises one or more separate conduction paths such as wires, vias, waveguides, passive components, and/or active components. It also comprises a fabric, in some embodiments. In some embodiments, p-unit 108 is coupled to OS 102 via an interface. Here the term “interface” generally refers to software and/or hardware used to communicate with an interconnect. An interface includes logic and I/O driver/receiver to send and receive data over the interconnect or one or more wires.

In some embodiments, each processor 103 is coupled to a power supply via voltage regulator. For example, the voltage regulator is internal to processor hardware 101 (e.g., on the package of processor hardware 101) or external to processor hardware 101. In some embodiments, each processor 103 includes IVR 107 that receives a primary regulated voltage from the voltage regulator of processor hardware 101 and generates an operating voltage for the agents of processor 103. In one such embodiment, such agents of processor 103 include some or all of the various components of processor 103 including modules 106 (and, for example, the cores 120 thereof), IVR 107, p-unit 108, and PLL/FLL 109. In various embodiments, modules 106 share IVR 107 (or, in other embodiments, are each provided a different respective IVR of processor 103-10).

Accordingly, an implementation of IVR 107 allows for fine-grained control of voltage and thus power and performance of each individual module 106. As such, each module 106 can operate at an independent voltage and frequency, enabling great flexibility and affording wide opportunities for balancing power consumption with performance. In some embodiments, the use of multiple IVRs enables the grouping of components into separate power planes, such that power is regulated and supplied by the IVR to only those components in the group. For example, during power management, a given power domain is able to be powered down or off with IVR 107 when module 106-2 is placed into a certain low power state, while another module (such as module 106-1) remains active, or fully powered. As such, IVR 107 is operable to control a certain domain of a logic or module 106. Here the term “domain” generally refers to a logical or physical perimeter that has similar properties (e.g., supply voltage, operating frequency, type of circuits or logic, and/or workload type) and/or is controlled by a particular agent. For example, a domain is a group of logic units or function units that are controlled by a particular supervisor. Such a domain is sometimes referred to as an Autonomous Perimeter (AP). By way of illustration and not limitation, a domain comprises an entire system-on-chip (SoC) or part of the SoC, and is governed by a p-unit, in some embodiments.

In some embodiments, a given processor 103 includes its own p-unit 108. P-unit 108 controls the power and/or performance of processor 103. For example, p-unit 108 controls power and/or performance (e.g., instructions per cycle, frequency, or the like) of each individual module 106. In various embodiments, p-unit 108 of each processor 103 is coupled via fabric 104. As such, respective p-units 108 of the processors 103 communicate—for example, with one another and OS 102—to determine the optimal power state of processor hardware 101 by controlling power states of individual modules 106 under their respective domains.

In an embodiment, p-unit 108 includes circuitry including hardware, software and/or firmware to perform power management operations with regard to processor 103. In some embodiments, p-unit 108 provides control information to voltage regulator of processor hardware 101 via an interface to cause the voltage regulator to generate the appropriate regulated voltage. In some embodiments, p-unit 108 provides control information to IVR 107 (and, in some embodiments, to additional voltage regulator logic of modules 106) via another interface to control the operating voltage generated (or to cause a corresponding IVR to be disabled in a low power mode). In some embodiments, p-unit 108 includes a variety of power management logic units to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software). In some embodiments, p-unit 108 is implemented as a microcontroller. The microcontroller can be an embedded microcontroller which is a dedicated controller or as a general-purpose controller. In some embodiments, p-unit 108 is implemented as a control logic configured to execute its own dedicated power management code, here referred to as pCode. In some embodiments, power management operations to be performed by p-unit 108 may be implemented externally to a processor 103, such as by way of a separate power management integrated circuit (PMIC) or other component external to processor hardware 101. In yet other embodiments, power management operations to be performed by p-unit 108 may be implemented within BIOS or other system software. In some embodiments, p-unit 108 of a processor 103 may assume a role of a supervisor or supervisee.

Here the term “supervisor” generally refers to a power controller, or power management, unit (a “p-unit”), which monitors and manages power and performance related parameters for one or more associated power domains, such as one or more processor modules, either alone or in cooperation with one or more other p-units. Examples of power/performance related parameters include, but are not limited to, domain power, platform power, voltage, voltage domain current, die current, load-line, temperature, device latency, utilization, clock frequency, processing efficiency, current/future workload information, and other parameters. In various embodiments, a supervisor receives, calculates, searches for or otherwise determines one or more new power or performance constraints (limits, average operational, etc.) for one or more domains. In one such embodiment, these one or more constraints are then communicated to one or more supervisee p-units, or directly to controlled or monitored agents, such as modules 106, via one or more fabrics and/or interconnects. By way of illustration and not limitation, a supervisor learns of the workload (present and future) of one or more dies, power measurements of the one or more dies, and other parameters (e.g., platform level power boundaries) and determines new performance constraints for the one or more dies. These performance constraints are then communicated by supervisor p-units to the supervisee p-units via one or more fabrics and/or interconnect. In examples where a die has one p-unit, a supervisor (Svor) p-unit is also referred to as supervisor die.

Here the term “supervisee” generally refers to a power controller, or power management, unit (a “p-unit”), which monitors and manages power and performance related parameters for one or more associated power domains, either alone or in cooperation with one or more other p-units and receives instructions from a supervisor to set power and/or performance parameters (e.g., supply voltage, operating frequency, maximum current, throttling threshold, etc.) for its associated power domain. In examples where a die has one p-unit, a supervisee (Svec) p-unit may also be referred to as a supervisee die. Note that a given p-unit is operable to serve either as a Svor, a Svec, or both a Svor/Svee p-unit, in various embodiments.

In various embodiments, p-unit 108 executes a firmware (referred to as pCode and/or aCode) that communicates with OS 102. In various embodiments, a given processor 103 includes a PLL or FLL 109 that generates a clock from p-unit 108 and input clock (or reference clock) for some or all modules 106 of processor 103-10. For example, modules 106 include or are otherwise associated with independent clock generation circuitry such as one or more PLLs to control operating frequency of each module 106 independently. In some embodiments, an input supply is received by a PMIC (power management integrated circuit) 110 which provides a regulated supply Vin to processor hardware 101. In some embodiments, Vin is used as input supply by local voltage regulator(s) to generate local supplies for one or more domains.

In some embodiments, each module 106 includes a p-unit that executes aCode, a firmware to manage core-level performance. In this example, module 106-1 includes a p-unit that executes aCode 112-1 to manage respective power states of the cores 120 of module 106-1. In some embodiments, pCode 113-10 of p-unit 108 communicates with aCode 112-1. The aCode associated with a given processor module can communicate with a local p-unit of that processor module, and/or with a supervisor p-unit which is external to that processor module.

In some embodiments, p-unit 108 and/or the local p-unit that execute aCode 112-1 implement an adaptive or dynamic power management scheme (hardware and/or software) that dynamically adjusts one or more operational characteristics including, for example, a dynamic capacitance (Cdyn), an operational frequency, a supply voltage and/or the like. In one such embodiment, the power management scheme dynamically adjusts Cdyn on core-specific basis (i.e., at a core level of granularity). Alternatively or in addition, the power management scheme dynamically adjusts an operational frequency, and/or a supply voltage on a per-module basis (i.e., at a module level of granularity).

In some embodiments, power management logic of module 106-1 monitors telemetry such as a rate of instruction executions, a type of instruction executions, and/or a Cdyn cost—such as a moving average Cdyn cost over a number of cycles (e.g., 64, 100, 2000, etc. cycles)—for one of cores 120. Based on such telemetry, power management logic (provided, for example, with p-unit 108, aCode 112-1, and/or local logic at the one of cores 120) determines whether execution by the one of cores 120 is to be throttled or, alternatively, whether multiple power state transitions are to be performed each with a different respective one of cores 120.

In an illustrative scenario according to one embodiment, an external software (or other) agent provides to processor 103-10 an indication of a performance constraint which is to be imposed on one or more of the modules 106. By way of illustration and not limitation, the performance constraint is provided to pCode 113-10 (or other suitable logic of p-unit 108) by aCode 112, pCode 113 and/or any of various other suitable resources which are external to processor 103-10. In an embodiment, the performance constraint is defined in a service level agreement (SLA) such as one with a cloud service provider (CSP) or other such entity. Examples of such a performance constraint include, but are not limited to, a frequency variability limit, a latency tolerance, a core performance metric, and/or any of various other key performance indicators (KPIs) such as one which is dependent on, or otherwise indicative of, an operational frequency of a core.

Based on such an indication of a performance constraint, p-unit 108 (for example, pCode 113-10 of p-unit 108) performs a calculation, look-up and/or any of various other suitable operations to identify one or more threshold values which are to be used for evaluating operational characteristics of cores 120. For example, pCode 113-10 identifies, for each of one or more possible power states of cores 120, a different respective test criteria which includes a corresponding threshold value (such as a threshold maximum Cdyn value). In one such embodiment, when cores 120 are each in a particular power state, evaluation of instruction execution by the cores 120 is to take place based on a current test criteria which includes the corresponding threshold value. Based on such evaluation, some embodiments variously select between power management options comprising (for example) a core throttling option, a power state transition option, and/or an option to forego any such throttling or power state transitioning.

In the example embodiment shown, core 120-1 comprises a Cdyn evaluation unit 122-1, a comparator 124-1, and an execution controller 126-1. The Cdyn evaluation unit 122-1 comprises circuitry to monitor an execution of instructions by an execution pipeline and/or other execution circuitry (not shown) of core 120-1. For example, Cdyn evaluation unit 122-1 identifies or otherwise detects the respective instruction types of some or all such instructions. Based on the detected instruction type(s), Cdyn evaluation unit 122-1 performs a look-up, calculation and/or other suitable operation to identify a corresponding Cdyn value for core 120-1 (such as an estimated and/or average Cdyn value).

In one such embodiment, Cdyn evaluation unit 122-1 communicates the determined Cdyn value to comparator 124-1, which is further configured to determine a current test criteria that corresponds to a currently configured power state of cores 120. Comparator 124-1 compares the determined Cdyn value to a threshold Cdyn value of a currently enforced test criteria—e.g., to determine whether core 120-1 violates (or, in some embodiments, is expected to violate) the current test criteria.

Based on the comparison, core 120 communicates to aCode 112-1 (or other suitable logic of module 106-1) whether or not core 120-1 has been identified as a violator core. In one such embodiment, each other core of module 106-1 similarly communicates to aCode 112-1 whether or not said other core has been identified as a violator core—e.g., wherein core 120-2 is identified to aCode 112-1 as violating (or alternatively, as satisfying) the current test criteria. By way of illustration and not limitation, core 120-2 comprises a Cdyn evaluation unit 122-2, a comparator 124-2, and an execution controller 126-2, which (for example) correspond functionally to Cdyn evaluation unit 122-1, comparator 124-1, and execution controller 126-1, respectively.

In an illustrative scenario according to one embodiment, aCode 112-1 determines whether a single violation condition, or (alternatively) a multiple violation condition, is indicated by communications with cores 120. Where a single violation condition is indicated, aCode 112-1 signals the violator core of module 106-1 to throttle an execution of instructions—e.g., wherein aCode 112-1 directly or indirectly indicates that execution controller 126-1 is to slow an execution of instructions by core 120-1. By way of illustration and not limitation, execution controller 126-1 signals instruction execution circuitry of core 120-1 to insert one or more bubbles—e.g., comprising no operation (NOOP) instructions—in an instruction stream. Alternatively or in addition, execution controller 126-1 (or other suitable circuitry of core 120-1) provides functionality to locally generate a modified version of the clock signal which is provided by PLL/FLL 109—e.g., by locally stretching (or alternatively, by squashing) pulses of the received clock signal.

In an alternative scenario, where a multiple violation condition is indicated, aCode 112-1 transitions each core of core 120-1 from a current power state to an alternative power state. For example, such a power state transition comprises operating IVR 107 to change a level of a supply voltage which is provide to each of cores 120. Alternatively or in addition, such a power state transition comprises operating PLL/FLL 109 to change a frequency of a clock signal which is provide to each of cores 120. In still another alternative scenario, where a “no violation condition” is indicated (that is, a condition wherein none of cores 120 violates the test criteria), each of cores 120 continues to operate in the currently configured power state—e.g., wherein none of the cores 120 is to be throttled.

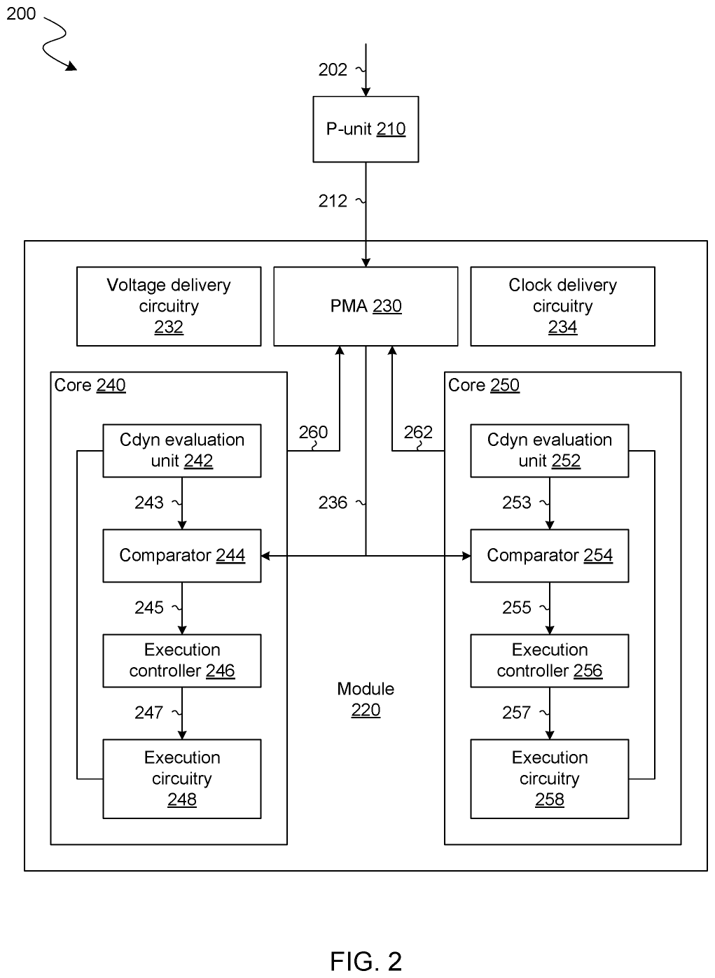

FIG. 2 shows features of a processor 200 which provides power management for two or more cores or a processor module according to an embodiment. Processor 200 illustrates an example embodiment which determines, based on a dynamic capacitance of one core, whether that one core is to be throttled, or—alternatively—whether two or more cores of the module are each to undergo a respective power state transition. In some embodiments, processor 200 provides functionality such as that of a processor 103 (for example).

As shown in FIG. 2, processor 200 comprises a p-unit 210 and one or more processor modules (e.g., comprising the illustrative module 220 shown) which are variously coupled to receive performance constraint information from p-unit 210. Based on the performance constraint information, cores of module 220 are each monitored to determine whether an execution of instructions, by one such core, is to be throttled. In various embodiments, such monitoring is to evaluate, for each of a plurality of cores, a respective dynamic capacitance (and/or any of various other suitable operational characteristics) of that core.

In the example embodiment shown, module 220 comprises voltage delivery circuitry 232, a power management agent (PMA) 230, a clock delivery circuitry 234, and multiple cores comprising (for example) a core 240 and another core 250. Voltage delivery circuitry 232 is coupled to receive a first supply voltage from a voltage regulator (not shown)—such as IVR 107, for example—which is external to module 220. In one such embodiment, cores 240, 250 each receive the first supply voltage (or another supply voltage which is based on the first supply voltage) from voltage delivery circuitry 232. Furthermore, clock delivery circuitry 234 is coupled to receive a first clock signal from a clock source (not shown)—such as PLL/FLL 109, for example—which is external to module 220. In an embodiment, cores 240, 250 each receive the first clock signal (or another clock signal which is based on the first clock signal) from clock delivery circuitry 234. Accordingly, cores 240, 250 (and any other cores of module 220, for example) share a power delivery domain which includes a common supply voltage and a common clock signal which, in some embodiments, corresponds to a common operational frequency.

In the embodiment shown, core 240 comprises a Cdyn evaluation unit 242, a comparator 244, and an execution controller 246 which—for example—correspond functionally to Cdyn evaluation unit 122-1, comparator 124-1, and execution controller 126-1 (respectively). Execution controller 246 controls at least some aspects of instruction execution by execution circuitry 248 of core 240—e.g., wherein execution controller 246 provides functionality to stall or otherwise throttle said instruction execution. In one such embodiment, core 250 comprises a Cdyn evaluation unit 252, a comparator 254, an execution controller 256, and execution circuitry 258 which, for example, provide functionality similar to that of Cdyn evaluation unit 242, a comparator 244, an execution controller 246, and execution circuitry 248 (respectively).

In an illustrative scenario according to one embodiment, p-unit 210 receives an indication 202 of a performance constraint such as a frequency variability limit, a latency tolerance, a core performance metric, and/or any of various other key performance indicators (KPIs). For example, indication 202 is provided to p-unit 210 by any of various suitable hardware resources, firmware resources, or executing software resources, such as a resource which provides functionality of aCode 112, pCode 113 or the like. In one such embodiment, p-unit 210 provides functionality (such as that of p-unit 108, for example) to identify one or more test criteria based on indication 202—e.g., wherein each of the one or more test criteria corresponds to a respective power state which is to be made available to cores 240, 250. For example, p-unit 210 performs any of various look-up, calculation and/or other suitable operations to identify a given test criteria based on the performance constraint. Based on such operations, p-unit 210 outputs test criteria information 212 which specifies or otherwise indicates a threshold Cdyn level.

PMA 230 is configured to receive the test criteria information 212 from p-unit 210, and to perform operations, based on test criteria information 212, to identify one or more threshold Cdyn levels which (for example) each corresponds to a respective power state of multiple available power states. Based on such operations, PMA 230 provides the one or more threshold Cdyn levels—e.g., including the illustrative Cdyn threshold value 236 shown—to each of cores 240, 250 (and, for example, to any other core of module 220).

For example, comparator 244 (and, in an embodiment, comparator 254) is coupled to receive Cdyn threshold value 236 from PMA 230. Comparator 244 further receives a Cdyn value 243 which Cdyn evaluation unit 242 determines based on a monitoring of instructions being execution by execution circuitry 248. Comparator 244 performs an evaluation of Cdyn value 243 based on Cdyn threshold value 236 to detect whether an execution of instructions by core 240 violates (or is expected to violate) the test criteria which includes or is otherwise based on Cdyn threshold value 236. Core 240 communicates a result of this evaluation to PMA 230 as an indication 260 which specifies or otherwise indicates whether core 240 is currently a violator core.

In an embodiment, PMA 230 further receives similar indications from each other core of module 220—e.g., wherein comparator 254 provides an indication 262 as to whether core 250 is currently a violator core. For example, Cdyn evaluation unit 252 similarly monitors instructions being execution by execution circuitry 258, where said monitoring is to determine a Cdyn value 253 which is provided to comparator 254, comparator 254 compares the Cdyn value 253 to the Cdyn threshold value 236, where a result of said comparison is communicated as indication 262 to PMA 230.

Based on indications 260, 262, PMA 230 identifies an instance of one of a single violation condition, a multiple violation condition, or a no violation condition for module 220. Where a single violation condition is identified, PMA 230 signals the violator core to throttle an execution of instructions. Alternatively, where a multiple violation condition is identified, PMA 230 (and/or other power management logic of processor 200) transitions the cores of module 220 each from a currently configured power state to a next power state.

In an illustrative scenario according to one embodiment, a single violation condition results in PMA 230 signaling to comparator 244 (or other suitable logic of core 240) that core 240 is to be throttled. In turn, comparator 244 outputs a signal 245 for execution controller 246 to throttle an execution of instructions by execution circuitry 248. For example, such throttling includes, or is otherwise based on, execution controller 246 providing a control signal 247 for execution circuitry 248 to provide one or more bubbles in an instruction sequence, to slow a fetching of instructions, or the like.

In an alternative scenario, a single violation condition results in PMA 230 signaling to comparator 254 (or other suitable logic of core 250) that core 250 is to be throttled. In turn, comparator 254 outputs a signal 255 for execution controller 256 to throttle an execution of instructions by execution circuitry 258. For example, such throttling includes, or is otherwise based on, execution controller 256 providing a control signal 257 for execution circuitry 258 to provide one or more bubbles in an instruction sequence, to slow a fetching of instructions, or the like.

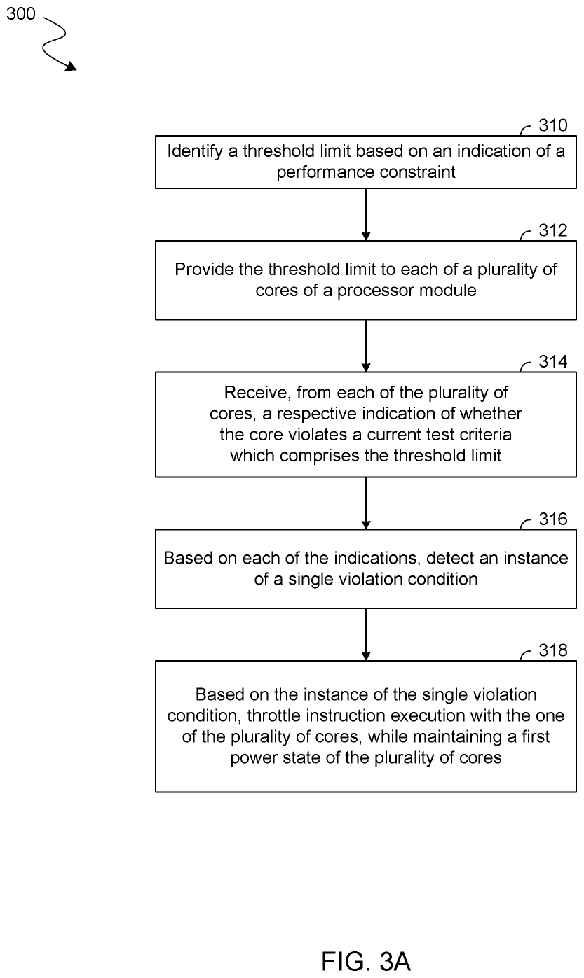

FIG. 3A shows a method 300 for determining operation of a processor module according to an embodiment. Operations such as those of method 300 are performed with any of various combinations of suitable hardware (e.g., circuitry), firmware and/or executing software which, for example, provide some or all of the functionality of system 100 or processor 200. In one such embodiment, method 300 is performed with processor 103-10, processor 200, or the like.

As shown in FIG. 3A, method 300 comprises (at 310) identifying a threshold limit based on an indication of a performance constraint. In one such embodiment, the identifying is performed with p-unit 210 and/or PMA 230—e.g., wherein the indication of the performance constraint is communicated as one of indication 202 or test criteria information 212. In an example embodiment, the performance constraint comprises a threshold maximum variance of an operational characteristic (such as an operational frequency) from a target value. In one such embodiment, the threshold limit is a threshold maximum dynamic capacitance level.

Method 300 further comprises (at 312) providing the threshold limit to each of a plurality of cores of a processor module. For example, each of the plurality of cores receives multiple threshold maximum Cdyn levels which, in some embodiments, each correspond to a different respective power state. Method 300 further comprises (at 314), for each core of the plurality of cores, receiving a different respective indication which identifies whether the core in question violates a currently enabled test criteria which comprises the threshold limit that is provided to the cores at 312. By way of illustration and not limitation, the multiple indications received at 314 comprise the indications 260, 262 which are received by PMA 230 from cores 240, 250 (respectively).

Based on the each of the multiple indications which are received at 314, method 300 (at 316) detects an instance of a single violation condition—e.g., comprising detecting an actual (or expected future) instance of one core of the plurality of cores violating the current test criteria, while each other core of the plurality of cores satisfies the current test criteria. Based on the identification of the instance at 316, method 300 (at 318) throttles an execution of instructions with the one of the plurality of cores. In an embodiment, the throttling is performed at 318 while the plurality of cores is maintained in a first power state from before the throttling to after the throttling. For example, any power state transition by the plurality of power states is performed independent of the identification of the instance of the single violation condition at 316.

In various embodiments, the throttling at 318 comprises inserting one or more bubbles (e.g., comprising one or more NOOP instructions) in an instruction pipeline of the violator core. Alternatively or in addition, the plurality of cores each receive—and execute instructions based on—a first clock signal, wherein (for example) the throttling at 318 comprises, at the identified violator core, generating a modified (relatively low frequency) version of the first clock signal for executing instructions at the violator. In one such embodiment, generating the modified version of the first clock signal comprises circuitry of the violator core squashing pulses—or alternatively, stretching pulses—of the received first clock signal. Alternatively or in addition, the throttling at 318 comprises slowing an instruction fetch unit (and/or other suitable circuitry) of the violator core.

In some embodiments, method 300 comprises a processor performing additional or alternative operations (not shown) which are similar in some respects to those described above. By way of illustration and not limitation, such operations further detect and/or respond to a second instance of the single violation condition—e.g., wherein a different one of the plurality of cores is the violator core, and/or wherein, at the time of such detection, a different test criteria is the current test criteria which is violated by the violator core. In an embodiment, such operations similarly throttle the same core (or alternatively, a different core) based on the second instance of the single violation condition—e.g., in lieu of transitioning the plurality of cores from a current power state.

In some embodiments, method 300 additionally or alternatively detects and responds to an instance of a multiple violation condition at the processor module. In one such embodiment, method 300 comprises transitioning the plurality of cores, based on the instance of the multiple violation condition, each from a current power state to an alternative power state.

In some embodiments, method 300 additionally or alternatively receives and processes indications, each from a different respective core of another module of the same processor, to detect and respond to an instance of a single violation condition (or alternatively, an instance of a multiple violation condition) at said other module. For example, in some embodiments, method 300 provides respective power management for multiple modules of the same core—e.g., wherein core throttling and/or power state transitions for one such module is performed independent of core throttling and/or power state transitions (if any) for another such module.

FIG. 3B shows a method 350 for determining operation of a processor module according to another embodiment. Method 350 illustrates one example of an embodiment wherein the execution of instructions with cores of a module is successively monitored and evaluated to determine whether a particular core is to be throttled, or whether each core of the module is to undergo a power state transition. Operations such as those of method 350 are performed with hardware (e.g., circuitry), firmware and/or executing software which, for example, provides functionality of processor 103-10 or processor 200 (for example)—e.g., wherein method 350 comprises some or all operations of method 300

As shown in FIG. 3B, method 350 comprises (at 360) receiving an indication of one or more performance constraints, and (at 362) identifying multiple threshold limits based on the based on the indication which is received at 360. In some embodiments, method 350 determines multiple threshold Cdyn levels based on a threshold maximum variance of an operational frequency for given core of the processor module in question. In one such embodiment, some or all of the multiple threshold Cdyn levels each correspond to a different respective power state—e.g., wherein one such threshold Cdyn level is a test criteria for determining whether a core is to transition to a higher consumption power state (or alternatively, to a lower consumption power state).

Method 350 further comprises (at 364) providing the multiple threshold limits to each of multiple cores of the processor module. In some embodiments, the cores each perform monitoring based on the received multiple threshold limits. For example, with a currently enforced test criteria which is based on one of the threshold limits (e.g., a test criteria which is based on a current power state of the module's cores), method 350 (at 366) evaluates respective instruction executions by the multiple cores. Based on the evaluating at 366, method 350 (at 368) makes a determination as to how many of the multiple cores (if any) violate—or are expected to violate—the current test criteria.

Where it is determined at 368 that none of the multiple cores violates the current test criteria (referred to herein as a no violation condition), method 350 (at 366) performs a next instance of the evaluating at 366 based on the same current test criteria—i.e., without throttling any of the multiple cores, and without performing a power state transition of the multiple cores.

Where it is instead determined at 368 that only one of the multiple cores violates the current test criteria—i.e., wherein each other core of the plurality of cores satisfies the current test criteria—method 350 (at 370) throttles an execution of instructions by the one core before performing a next instance of the evaluating at 366 based on the same current test criteria. In an embodiment, the throttling at 370 is performed while the cores of the processor module remain in the current power state.

Where it is instead determined at 368 that two or more of the multiple cores violates the current test criteria, method 350 (at 372) transitions the multiple cores each from one power state to an alternative power state. Furthermore, method 350 (at 374) identifies a next test criteria which corresponds to the current (most recently configured at 372) power state. Further still, method 350 (at 376) sets this next test criteria to be the current test criteria for use in a next instance of the evaluating at 366.

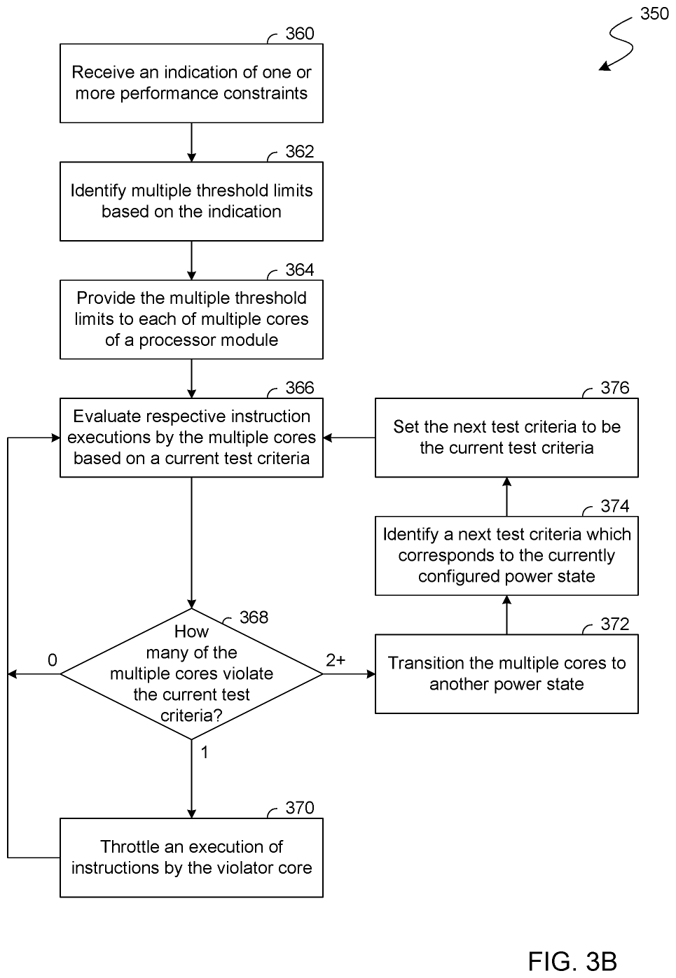

FIG. 4 shows a graph 400 illustrating operational characteristics of a processor module according to an embodiment. In various embodiments, graph 400 illustrates features of a processor module such as module 106 or module 220—e.g., wherein operations of one of methods 300, 350 are performed with said processor module.

As shown in FIG. 4, graph 400 includes a plot 410 illustrating a relationship, provided by a power management scheme, of a dynamic capacitance 404 of a processor core to a range of values for an operational frequency 402 of the processor core. Graph 400 further shows an operational point 412 which corresponds to a maximum current IccMax for such a processor core, in accordance with some embodiments. A dashed line 422 in graph 400 shows a hypothetical idealized Cdyn-frequency curve (e.g., a curve with infinite granularity).

Plot 410 illustrates a 4-threshold power management scheme according to some embodiments, where the illustrative points a, b, c, and d shown correspond to threshold dynamic capacitance levels Cdyn2, Cdyn3, Cdyn4, Cdyn_th (respectively). In one such embodiment, power management selectively adjusts a given core's IccMax to any one of the various corresponding levels—e.g., one of an Icc level for point a, an Icc level for at point b, an Icc level for point c, or an Icc level for point d) which are less than or equal to the IccMax at point 412. Plot 410 tends to the ideal dashed line 420 as the number of Cdyn thresholds is increased.

Some embodiments variously provide an adaptive control mechanism that dynamically adjusts a threshold maximum dynamic capacitance (CdynMax) for a given core by selectively providing any of multiple available power states of the core—e.g., including selectively providing any of multiple frequencies for a clock signal which is provided to each of multiple cores of a processor module.

In various embodiments, a power state transition is performed where multiple cores of a processor module are each determined to be a violator core. Alternatively, a power state transition is instead avoided where (for example) only one core of the module is determined to be a violator core. For example, such embodiments instead throttle an execution of at least some instructions by the one violator core. In some embodiments, throttling is performed for only one or more instruction sequences which are executed at the one violator core, wherein no such throttling is performed for one or more other instruction sequences which are also executed at the one violator core. For example, throttling is performed for one virtualization process of the one violator core—such as a virtual machine (VM) process or a VM monitor (VMM) process—e.g., wherein one or more (virtualization or other) processes continue to execute each at a respective same average rate.

By way of illustration and not limitation, the point A shown in plot 410 represents a first operational state of a first core of a processor module, wherein the point B1 represents a second operational state (concurrent with the first operational state) of a second core of the same processor module. In an illustrative scenario according to one embodiment, a dynamic capacitance of the second core begins to increase—e.g., due to an increased occurrence of instructions of a type which is associated with relatively high processing load. As a result, the second core begins to move toward another operational state, which is represented by the point B2 in plot 410. The point B2—as compared to points A, B1—corresponds to a different operational frequency (of a different power state), and to a different range of Cdyn values, in plot 410. Accordingly, a transition from point B1 to point B2 would require the second core to transition to a different power state—i.e., but for the selective core throttling functionality which is provided according to various embodiments. For example, some embodiments detect that—while the first core is at the first operational state—the second core is transitioning (or has transitioned) toward the operational state which corresponds to point B2. To avoid or remedy a need to perform a power state transition, some embodiments selectively throttle an execution of instructions by the second core—e.g., while the first core is protected from any such throttling. Based on such selective throttling, a Cdyn of the second core remains under (or returns to below) a threshold maximum level Cdyn3 for the current power state which is provided for both the first core and the second core.

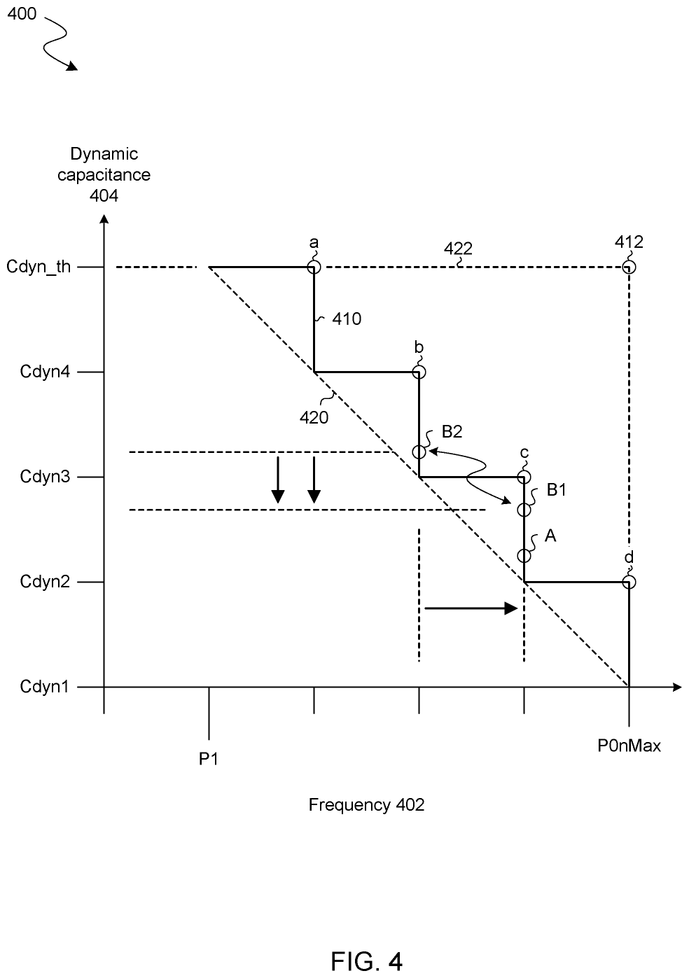

FIG. 5 shows a timing diagram 500 illustrating operational characteristics of a processor module according to an embodiment. Timing diagram 500 demonstrates operations by cores of a processor module, wherein said operations are based on a power management scheme which selectively throttles a given core based on the detection of a single violation condition. In an embodiment, operations such as those illustrated in timing diagram 500 are performed (for example) with processor 103-10, or processor 200—e.g., wherein such operations include, or are otherwise based on, one of methods 300, 350 (for example).

In FIG. 5, timing diagram 500 shows plots 510, 520 which illustrate, for a first core and a second core (respectively) of a processor module, changes to a respective dynamic capacitance 504 over time 502. Timing diagram 500 further shows a plot 530 which illustrates changes over time 502 to a frequency 506 of a clock signal which is provided to each of the first core and the second core (and, of example, to any other core of the processor module).

In an illustrative scenario according to one embodiment, the cores of the module, at a time t₁, are each in a first power state which comprises a frequency f₂ of a clock signal which is provided to each core of the processor module. The first power state corresponds to a threshold minimum dynamic capacitance level Cdyn2, below which the cores of the module are to be transitioned to a second power state which comprises a relatively high frequency (not shown) of the clock signal. The first power state further corresponds to a threshold maximum dynamic capacitance level Cdyn3, above which the cores of the module are to be transitioned to a third power state which comprises a relatively low frequency f₁ of the clock signal.

Before the time t₁, plots 510, 520 are each between the threshold levels Cdyn2, Cdyn3. At some point after time t₁, the Cdyn of the first core begins to increase—e.g., due at least in part to increased instances of the first core executing instructions which are of an instruction type which is associated with higher Cdyn. Subsequently, at time t₂, power management logic according to one embodiment performs an evaluation which detects an instance of a single violation condition. More particularly, the power management logic detects that the first core has violated (or is at risk of violating) a test criteria which includes, or is otherwise based on, the threshold level Cdyn3, while the second core (and any other core of the processor module) satisfies the test criteria. In one such embodiment, detecting the single violation condition comprises detecting that the Cdyn of the first core is above another predetermined threshold level Ctest, which is marginally lower than the threshold level Cdyn3.

In response to detecting the single violation condition, the power management logic throttles an execution of instructions by the first core—e.g., wherein the second core (and, for example, any other core of the processor module) is omitted from any such throttling. In an embodiment, the throttling of the first core results in plot 510 returning to below the threshold level Ctest (for example) and, by a time t₃, settling again to a level which is between the threshold levels Cdyn2, Cdyn3.

Subsequently, at or around a time t₄, the Cdyn of the second core (indicated by plot 520) begins to increase—e.g., due at least in part to a type of instructions being executed with the second core. At some subsequent time t₅, the Cdyn of the first core (indicated by plot 510) also begins to similarly increase. At a time t₆, the power management logic performs another evaluation which detects an instance of a multiple violation condition. More particularly, the power management logic detects, for each of the first core and the second core, that the core has violated (or is at risk of violating) the test criteria which is based on the threshold level Cdyn3.

In one such embodiment, detecting the multiple violation condition comprises detecting that the Cdyn of first core exceeds the threshold level Ctest, while that the Cdyn of the second core is imminently expected (according to some predetermined standard) to exceed the threshold level Ctest. In response to detecting the multiple violation condition, the power management logic transitions all cores of the module—that is, including the first core and the second core—from the first power state to the third power state (which comprises the clock signal having the frequency f₁).

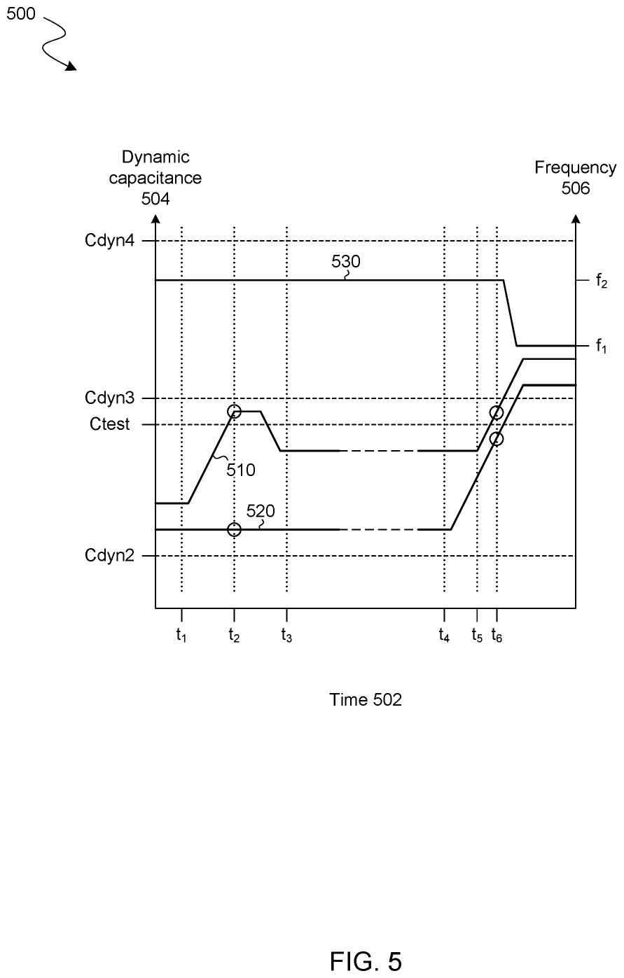

FIG. 6 illustrates a computer system or computing device 600 (also referred to as device 600), where power management of a processor is provided in accordance with some embodiments. It is pointed out that those elements of FIG. 6 having the same reference numbers (or names) as the elements of any other figure can operate or function in any manner similar to that described, but are not limited to such.

In some embodiments, device 600 represents an appropriate computing device, such as a computing tablet, a mobile phone or smart-phone, a laptop, a desktop, an Internet-of-Things (IOT) device, a server, a wearable device, a set-top box, a wireless-enabled e-reader, or the like. It will be understood that certain components are shown generally, and not all components of such a device are shown in device 600.

In an example, the device 600 comprises a SoC (System-on-Chip) 601. An example boundary of the SOC 601 is illustrated using dotted lines in FIG. 6, with some example components being illustrated to be included within SOC 601—however, SOC 601 may include any appropriate components of device 600.

In some embodiments, device 600 includes processor 604. Processor 604 can include one or more physical devices, such as microprocessors, application processors, microcontrollers, programmable logic devices, processing cores, or other processing means. The processing operations performed by processor 604 include the execution of an operating platform or operating system on which applications and/or device functions are executed. The processing operations include operations related to I/O (input/output) with a human user or with other devices, operations related to power management, operations related to connecting computing device 600 to another device, and/or the like. The processing operations may also include operations related to audio I/O and/or display I/O.

In some embodiments, processor 604 includes multiple processing cores (also referred to as cores) 608a, 608b, 608c. Although merely three cores 608a, 608b, 608c are illustrated in FIG. 6, the processor 604 may include any other appropriate number of processing cores, e.g., tens, or even hundreds of processing cores. Processor cores 608a, 608b, 608c may be implemented on a single integrated circuit (IC) chip. Moreover, the chip may include one or more shared and/or private caches, buses or interconnections, graphics and/or memory controllers, or other components.

In some embodiments, processor 604 includes cache 606. In an example, sections of cache 606 may be dedicated to individual cores 608 (e.g., a first section of cache 606 dedicated to core 608a, a second section of cache 606 dedicated to core 608b, and so on). In an example, one or more sections of cache 606 may be shared among two or more of cores 608. Cache 606 may be split in different levels, e.g., level 1 (L1) cache, level 2 (L2) cache, level 3 (L3) cache, etc.

In some embodiments, a given processor core (e.g., core 608a) may include a fetch unit to fetch instructions (including instructions with conditional branches) for execution by the core 608a. The instructions may be fetched from any storage devices such as the memory 630. Processor core 608a may also include a decode unit to decode the fetched instruction. For example, the decode unit may decode the fetched instruction into a plurality of micro-operations. Processor core 608a may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, an execution unit may execute instructions out-of-order. Hence, processor core 608a (for example) may be an out-of-order processor core in one embodiment. Processor core 608a may also include a retirement unit. The retirement unit may retire executed instructions after they are committed. In an embodiment, retirement of the executed instructions may result in processor state being committed from the execution of the instructions, physical registers used by the instructions being de-allocated, etc. The processor core 608a may also include a bus unit to enable communication between components of the processor core 608a and other components via one or more buses. Processor core 608a may also include one or more registers to store data accessed by various components of the core 608a (such as values related to assigned app priorities and/or sub-system states (modes) association.

In some embodiments, device 600 comprises connectivity circuitries 631. For example, connectivity circuitries 631 includes hardware devices (e.g., wireless and/or wired connectors and communication hardware) and/or software components (e.g., drivers, protocol stacks), e.g., to enable device 600 to communicate with external devices. Device 600 may be separate from the external devices, such as other computing devices, wireless access points or base stations, etc.

In an example, connectivity circuitries 631 may include multiple different types of connectivity. To generalize, the connectivity circuitries 631 may include cellular connectivity circuitries, wireless connectivity circuitries, etc. Cellular connectivity circuitries of connectivity circuitries 631 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 631 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 631 may include a network interface, such as a wired or wireless interface, e.g., so that a system embodiment may be incorporated into a wireless device, for example, cell phone or personal digital assistant.

In some embodiments, device 600 comprises control hub 632, which represents hardware devices and/or software components related to interaction with one or more I/O devices. For example, processor 604 may communicate with one or more of display 622, one or more peripheral devices 624, storage devices 628, one or more other external devices 629, etc., via control hub 632. Control hub 632 may be a chipset, a Platform Control Hub (PCH), and/or the like.

For example, control hub 632 illustrates one or more connection points for additional devices that connect to device 600, e.g., through which a user might interact with the system. For example, devices (e.g., devices 629) that can be attached to device 600 include microphone devices, speaker or stereo systems, audio devices, video systems or other display devices, keyboard or keypad devices, or other I/O devices for use with specific applications such as card readers or other devices.

As mentioned above, control hub 632 can interact with audio devices, display 622, etc. For example, input through a microphone or other audio device can provide input or commands for one or more applications or functions of device 600. Additionally, audio output can be provided instead of, or in addition to display output. In another example, if display 622 includes a touch screen, display 622 also acts as an input device, which can be at least partially managed by control hub 632. There can also be additional buttons or switches on computing device 600 to provide I/O functions managed by control hub 632. In one embodiment, control hub 632 manages devices such as accelerometers, cameras, light sensors or other environmental sensors, or other hardware that can be included in device 600. The input can be part of direct user interaction, as well as providing environmental input to the system to influence its operations (such as filtering for noise, adjusting displays for brightness detection, applying a flash for a camera, or other features).

In some embodiments, control hub 632 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 622 represents hardware (e.g., display devices) and software (e.g., drivers) components that provide a visual and/or tactile display for a user to interact with device 600. Display 622 may include a display interface, a display screen, and/or hardware device used to provide a display to a user. In some embodiments, display 622 includes a touch screen (or touch pad) device that provides both output and input to a user. In an example, display 622 may communicate directly with the processor 604. Display 622 can be one or more of an internal display device, as in a mobile electronic device or a laptop device or an external display device attached via a display interface (e.g., DisplayPort, etc.). In one embodiment display 622 can be a head mounted display (HMD) such as a stereoscopic display device for use in virtual reality (VR) applications or augmented reality (AR) applications.

In some embodiments and although not illustrated in the figure, in addition to (or instead of) processor 604, device 600 may include Graphics Processing Unit (GPU) comprising one or more graphics processing cores, which may control one or more aspects of displaying contents on display 622.

Control hub 632 (or platform controller hub) may include hardware interfaces and connectors, as well as software components (e.g., drivers, protocol stacks) to make peripheral connections, e.g., to peripheral devices 624.

It will be understood that device 600 could both be a peripheral device to other computing devices, as well as have peripheral devices connected to it. Device 600 may have a “docking” connector to connect to other computing devices for purposes such as managing (e.g., downloading and/or uploading, changing, synchronizing) content on device 600. Additionally, a docking connector can allow device 600 to connect to certain peripherals that allow computing device 600 to control content output, for example, to audiovisual or other systems.

In addition to a proprietary docking connector or other proprietary connection hardware, device 600 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 631 may be coupled to control hub 632, e.g., in addition to, or instead of, being coupled directly to the processor 604. In some embodiments, display 622 may be coupled to control hub 632, e.g., in addition to, or instead of, being coupled directly to processor 604.

In some embodiments, device 600 comprises memory 630 coupled to processor 604 via memory interface 634. Memory 630 includes memory devices for storing information in device 600. Memory can include nonvolatile (state does not change if power to the memory device is interrupted) and/or volatile (state is indeterminate if power to the memory device is interrupted) memory devices. Memory device 630 can be a dynamic random access memory (DRAM) device, a static random access memory (SRAM) device, flash memory device, phase-change memory device, or some other memory device having suitable performance to serve as process memory. In one embodiment, memory 630 can operate as system memory for device 600, to store data and instructions for use when the one or more processors 604 executes an application or process. Memory 630 can store application data, user data, music, photos, documents, or other data, as well as system data (whether long-term or temporary) related to the execution of the applications and functions of device 600.

Elements of various embodiments and examples are also provided as a machine-readable medium (e.g., memory 630) for storing the computer-executable instructions (e.g., instructions to implement any other processes discussed herein). The machine-readable medium (e.g., memory 630) may include, but is not limited to, flash memory, optical disks, CD-ROMs, DVD ROMs, RAMS, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 600 comprises temperature measurement circuitries 640, e.g., for measuring temperature of various components of device 600. In an example, temperature measurement circuitries 640 may be embedded, or coupled or attached to various components, whose temperature are to be measured and monitored. For example, temperature measurement circuitries 640 may measure temperature of (or within) one or more of cores 608a, 608b, 608c, voltage regulator 614, memory 630, a mother-board of SOC 601, and/or any appropriate component of device 600.

In some embodiments, device 600 comprises power measurement circuitries 642, e.g., for measuring power consumed by one or more components of the device 600. In an example, in addition to, or instead of, measuring power, the power measurement circuitries 642 may measure voltage and/or current. In an example, the power measurement circuitries 642 may be embedded, or coupled or attached to various components, whose power, voltage, and/or current consumption are to be measured and monitored. For example, power measurement circuitries 642 may measure power, current and/or voltage supplied by one or more voltage regulators 614, power supplied to SOC 601, power supplied to device 600, power consumed by processor 604 (or any other component) of device 600, etc.

In some embodiments, device 600 comprises one or more voltage regulator circuitries, generally referred to as voltage regulator (VR) 614. VR 614 generates signals at appropriate voltage levels, which may be supplied to operate any appropriate components of the device 600. Merely as an example, VR 614 is illustrated to be supplying signals to processor 604 of device 600. In some embodiments, VR 614 receives one or more Voltage Identification (VID) signals, and generates the voltage signal at an appropriate level, based on the VID signals. Various type of VRs may be utilized for the VR 614. For example, VR 614 may include a “buck” VR, “boost” VR, a combination of buck and boost VRs, low dropout (LDO) regulators, switching DC-DC regulators, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR which is controlled by PCU 610a/b and/or PMIC 612. In some embodiments, each core has a network of distributed LDOs to provide efficient control for power management. The LDOs can be digital, analog, or a combination of digital or analog LDOs.

In some embodiments, device 600 comprises one or more clock generator circuitries, generally referred to as clock generator 616. Clock generator 616 generates clock signals at appropriate frequency levels, which may be supplied to any appropriate components of device 600. Merely as an example, clock generator 616 is illustrated to be supplying clock signals to processor 604 of device 600. In some embodiments, clock generator 616 receives one or more Frequency Identification (FID) signals, and generates the clock signals at an appropriate frequency, based on the FID signals.

In some embodiments, device 600 comprises battery 618 supplying power to various components of device 600. Merely as an example, battery 618 is illustrated to be supplying power to processor 604. Although not illustrated in the figures, device 600 may comprise a charging circuitry, e.g., to recharge the battery, based on Alternating Current (AC) power supply received from an AC adapter.

In some embodiments, device 600 comprises Power Control Unit (PCU) 610 (also referred to as Power Management Unit (PMU), Power Controller, etc.). In an example, some sections of PCU 610 may be implemented by one or more processing cores 608, and these sections of PCU 610 are symbolically illustrated using a dotted box and labelled PCU 610a. In an example, some other sections of PCU 610 may be implemented outside the processing cores 608, and these sections of PCU 610 are symbolically illustrated using a dotted box and labelled as PCU 610b. PCU 610 may implement various power management operations for device 600. PCU 610 may include hardware interfaces, hardware circuitries, connectors, registers, etc., as well as software components (e.g., drivers, protocol stacks), to implement various power management operations for device 600.

In some embodiments, device 600 comprises Power Management Integrated Circuit (PMIC) 612, e.g., to implement various power management operations for device 600. In some embodiments, PMIC 612 is a Reconfigurable Power Management ICs (RPMICs) and/or an IMVP (Intel® Mobile Voltage Positioning). In an example, the PMIC is within an IC chip separate from processor 604. The may implement various power management operations for device 600. PMIC 612 may include hardware interfaces, hardware circuitries, connectors, registers, etc., as well as software components (e.g., drivers, protocol stacks), to implement various power management operations for device 600.

In an example, device 600 comprises one or both PCU 610 or PMIC 612. In an example, any one of PCU 610 or PMIC 612 may be absent in device 600, and hence, these components are illustrated using dotted lines.

Various power management operations of device 600 may be performed by PCU 610, by PMIC 612, or by a combination of PCU 610 and PMIC 612. For example, PCU 610 and/or PMIC 612 may select a power state (e.g., P-state) for various components of device 600. For example, PCU 610 and/or PMIC 612 may select a power state (e.g., in accordance with the ACPI (Advanced Configuration and Power Interface) specification) for various components of device 600. Merely as an example, PCU 610 and/or PMIC 612 may cause various components of the device 600 to transition to a sleep state, to an active state, to an appropriate C state (e.g., CO state, or another appropriate C state, in accordance with the ACPI specification), etc. In an example, PCU 610 and/or PMIC 612 may control a voltage output by VR 614 and/or a frequency of a clock signal output by the clock generator, e.g., by outputting the VID signal and/or the FID signal, respectively. In an example, PCU 610 and/or PMIC 612 may control battery power usage, charging of battery 618, and features related to power saving operation.

The clock generator 616 can comprise a phase locked loop (PLL), frequency locked loop (FLL), or any suitable clock source. In some embodiments, each core of processor 604 has its own clock source. As such, each core can operate at a frequency independent of the frequency of operation of the other core. In some embodiments, PCU 610 and/or PMIC 612 performs adaptive or dynamic frequency scaling or adjustment. For example, clock frequency of a processor core can be increased if the core is not operating at its maximum power consumption threshold or limit. In some embodiments, PCU 610 and/or PMIC 612 determines the operating condition of each core of a processor, and opportunistically adjusts frequency and/or power supply voltage of that core without the core clocking source (e.g., PLL of that core) losing lock when the PCU 610 and/or PMIC 612 determines that the core is operating below a target performance level. For example, if a core is drawing current from a power supply rail less than a total current allocated for that core or processor 604, then PCU 610 and/or PMIC 612 can temporarily increase the power draw for that core or processor 604 (e.g., by increasing clock frequency and/or power supply voltage level) so that the core or processor 604 can perform at a higher performance level. As such, voltage and/or frequency can be increased temporality for processor 604 without violating product reliability.

In an example, PCU 610 and/or PMIC 612 may perform power management operations, e.g., based at least in part on receiving measurements from power measurement circuitries 642, temperature measurement circuitries 640, charge level of battery 618, and/or any other appropriate information that may be used for power management. To that end, PMIC 612 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 610 and/or PMIC 612 in at least one embodiment to allow PCU 610 and/or PMIC 612 to manage processor core energy at least in part based on value(s) detected by one or more of the sensors.

Also illustrated is an example software stack of device 600 (although not all elements of the software stack are illustrated). Merely as an example, processors 604 may execute application programs 650, Operating System 652, one or more Power Management (PM) specific application programs (e.g., generically referred to as PM applications 658), and/or the like. PM applications 658 may also be executed by the PCU 610 and/or PMIC 612. OS 652 may also include one or more PM applications 656a, 656b, 656c. The OS 652 may also include various drivers 654a, 654b, 654c, etc., some of which may be specific for power management purposes. In some embodiments, device 600 may further comprise a Basic Input/Output System (BIOS) 620. BIOS 620 may communicate with OS 652 (e.g., via one or more drivers 654), communicate with processors 604, etc.

For example, one or more of PM applications 658, 656, drivers 654, BIOS 620, etc. may be used to implement power management specific tasks, e.g., to control voltage and/or frequency of various components of device 600, to control wake-up state, sleep state, and/or any other appropriate power state of various components of device 600, control battery power usage, charging of the battery 618, features related to power saving operation, etc.

In various embodiments, processor 604 comprises one or more processor modules which each correspond to a different respective voltage domain and/or clock domain. For example, one such module comprises multiple cores (e.g., including two or more of cores 608a-c) which share a common power delivery domain comprising, for example, a shared power supply and a shared clock signal. In one such embodiment, power management for the cores of such a module comprises selectively throttling one core in the case of a single violation condition being detected. Additionally or alternatively, such power management comprises performing a power state transition for all cores of the module in the case of a multiple violation condition being detected.

### Exemplary Computer Architectures.

Detailed below are describes of exemplary computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

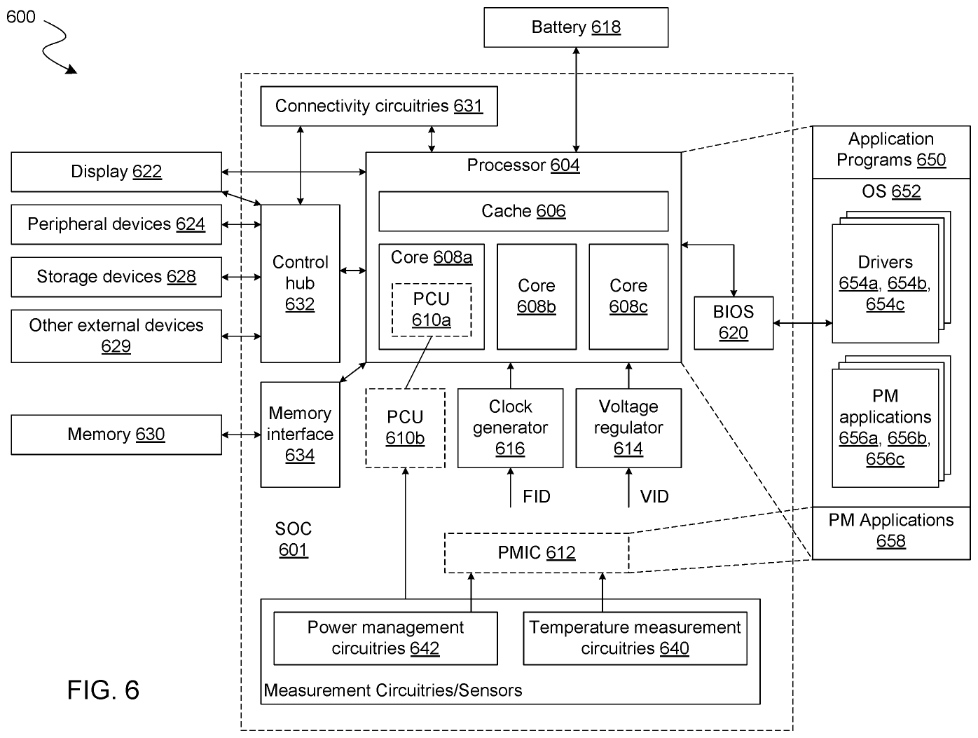

FIG. 7 illustrates an exemplary system. Multiprocessor system 700 is a point-to-point interconnect system and includes a plurality of processors including a first processor 770 and a second processor 780 coupled via a point-to-point interconnect 750. In some examples, the first processor 770 and the second processor 780 are homogeneous. In some examples, first processor 770 and the second processor 780 are heterogenous. Though the exemplary system 700 is shown to have two processors, the system may have three or more processors, or may be a single processor system.

Processors 770 and 780 are shown including integrated memory controller (IMC) circuitry 772 and 782, respectively. Processor 770 also includes as part of its interconnect controller point-to-point (P-P) interfaces 776 and 778; similarly, second processor 780 includes P-P interfaces 786 and 788. Processors 770, 780 may exchange information via the point-to-point (P-P) interconnect 750 using P-P interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a chipset 790 via individual P-P interconnects 752, 754 using point to point interface circuits 776, 794, 786, 798. Chipset 790 may optionally exchange information with a coprocessor 738 via an interface 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via P-P interconnect, such that either or both processors' local cache information may be stored in the shared cache if a processor is placed into a low power mode.

Chipset 790 may be coupled to a first interconnect 716 via an interface 796. In some examples, first interconnect 716 may be a Peripheral Component Interconnect (PCI) interconnect, or an interconnect such as a PCI Express interconnect or another I/O interconnect. In some examples, one of the interconnects couples to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interconnect 716, along with a bus bridge 718 which couples first interconnect 716 to a second interconnect 720. In some examples, one or more additional processor(s) 715, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 716. In some examples, second interconnect 720 may be a low pin count (LPC) interconnect. Various devices may be coupled to second interconnect 720 including, for example, a keyboard and/or mouse 722, communication devices 727 and a storage circuitry 728. Storage circuitry 728 may be one or more non-transitory machine-readable storage media as described below, such as a disk drive or other mass storage device which may include instructions/code and data 730, in some examples. Further, an audio I/O 724 may be coupled to second interconnect 720. Note that other architectures than the point-to-point architecture described above are possible. For example, instead of the point-to-point architecture, a system such as multiprocessor system 700 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

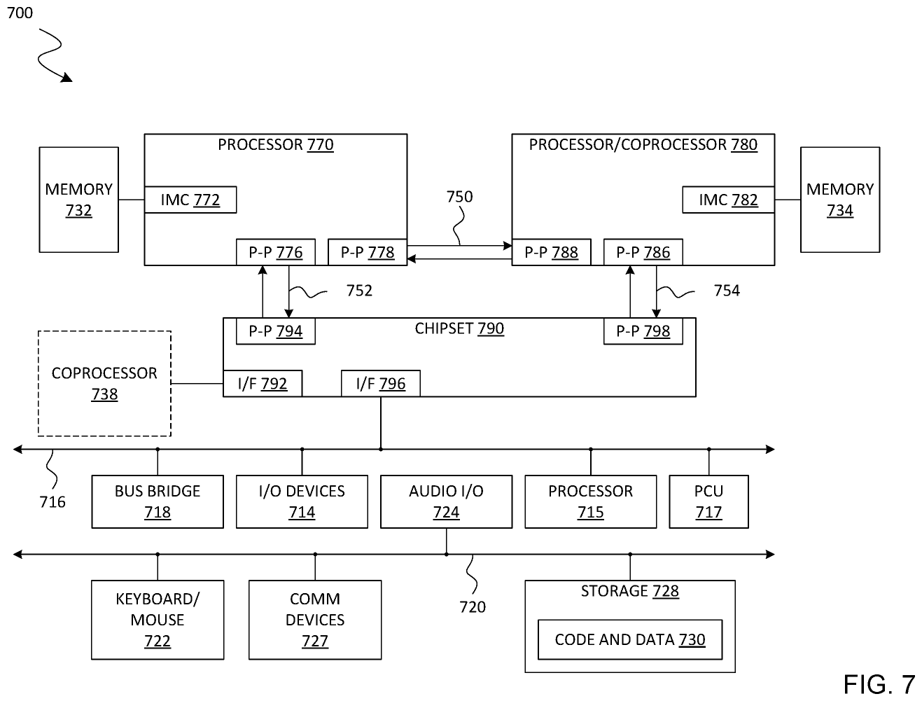

FIG. 8 illustrates a block diagram of an example processor 800 that may have more than one core and an integrated memory controller. The solid lined boxes illustrate a processor 800 with a single core 802A, a system agent unit circuitry 810, a set of one or more interconnect controller unit(s) circuitry 816, while the optional addition of the dashed lined boxes illustrates an alternative processor 800 with multiple cores 802A-N, a set of one or more integrated memory controller unit(s) circuitry 814 in the system agent unit circuitry 810, and special purpose logic 808, as well as a set of one or more interconnect controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802A-N being one or more general purpose cores (e.g., general purpose in-order cores, general purpose out-of-order cores, or a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804A-N within the cores 802A-N, a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples ring-based interconnect network circuitry 812 interconnects the special purpose logic 808 (e.g., integrated graphics logic), the set of shared cache unit(s) circuitry 806, and the system agent unit circuitry 810, alternative examples use any number of well-known techniques for interconnecting such units. In some examples, coherency is maintained between one or more of the shared cache unit(s) circuitry 806 and cores 802A-N.

In some examples, one or more of the cores 802A-N are capable of multi-threading. The system agent unit circuitry 810 includes those components coordinating and operating cores 802A-N. The system agent unit circuitry 810 may include, for example, power control unit (PCU) circuitry and/or display unit circuitry (not shown). The PCU may be or may include logic and components needed for regulating the power state of the cores 802A-N and/or the special purpose logic 808 (e.g., integrated graphics logic). The display unit circuitry is for driving one or more externally connected displays.

The cores 802A-N may be homogenous in terms of instruction set architecture (ISA). Alternatively, the cores 802A-N may be heterogeneous in terms of ISA; that is, a subset of the cores 802A-N may be capable of executing an ISA, while other cores may be capable of executing only a subset of that ISA or another ISA.

### Exemplary Core Architectures-In-Order and Out-of-Order Core Block Diagram.

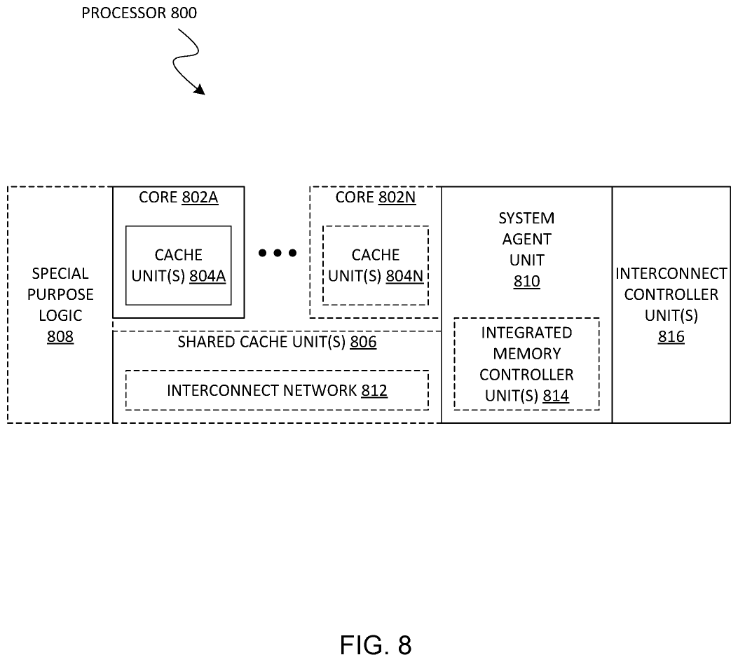

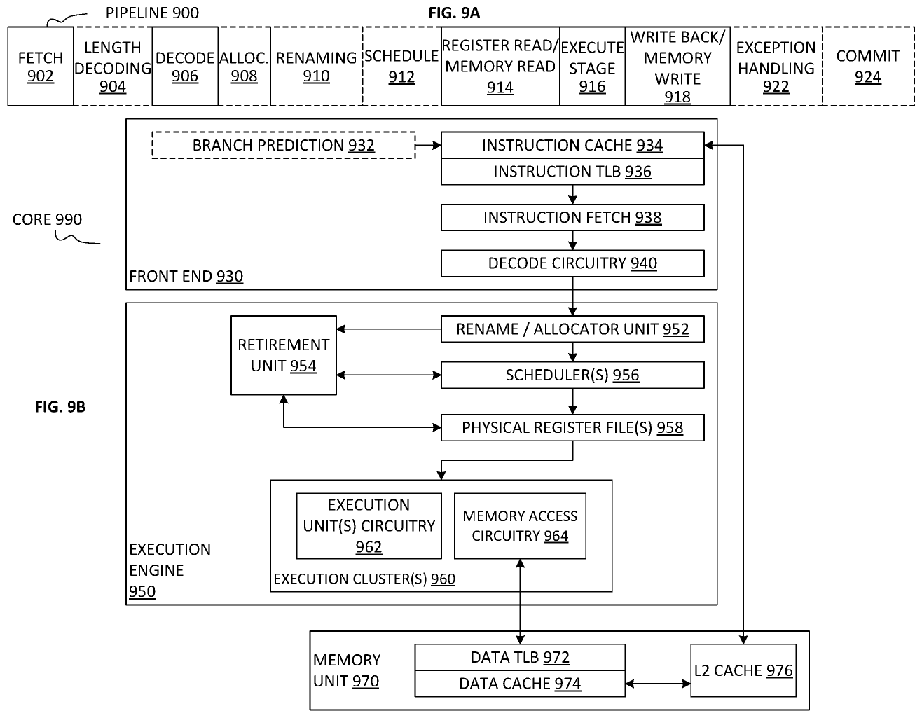

FIG. 9A is a block diagram illustrating both an exemplary in-order pipeline and an exemplary register renaming, out-of-order issue/execution pipeline according to examples. FIG. 9B is a block diagram illustrating both an exemplary example of an in-order architecture core and an exemplary register renaming, out-of-order issue/execution architecture core to be included in a processor according to examples. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 906 and the register read/memory read stage 914 may be combined into one pipeline stage. In one example, during the execute stage 916, the decoded instructions may be executed. LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 9B may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9B shows a processor core 990 including front-end unit circuitry 930 coupled to an execution engine unit circuitry 950, and both are coupled to a memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit circuitry 930 may include branch prediction circuitry 932 coupled to an instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to a retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, arithmetic generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to a data cache circuitry 974 coupled to a level 2 (L2) cache circuitry 976. In one exemplary example, the memory access circuitry 964 may include a load unit circuitry, a store address unit circuit, and a store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, a level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 990 includes logic to support a packed data instruction set architecture extension (e.g., AVX1, AVX2), thereby allowing the operations used by many multimedia applications to be performed using packed data.

### Exemplary Execution Unit(s) Circuitry.

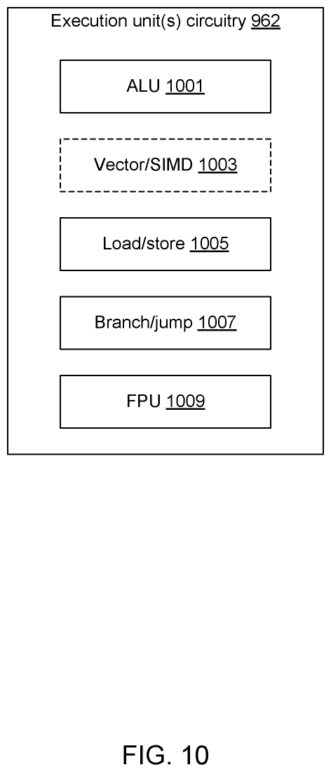

FIG. 10 illustrates examples of execution unit(s) circuitry, such as execution unit(s) circuitry 962 of FIG. 9B. As illustrated, execution unit(s) circuitry 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In one or more first embodiments, a processor comprises first circuitry to identify a threshold limit based on an indication of a performance constraint, provide the threshold limit to each of multiple cores of a processor module, wherein each of the multiple cores is to receive a first supply voltage, and wherein each of the multiple cores is to receive a first clock signal, receive multiple indications each from a different respective one of the multiple cores, wherein, for each core of the multiple cores, a respective one of the multiple indications identifies whether the core violates a current test criteria which is based on the threshold limit, and based on each of the multiple indications, detect an instance of a single violation condition wherein one core of the multiple cores violates the current test criteria, while each other core of the multiple cores satisfies the current test criteria, and second circuitry coupled to the first circuitry, wherein, based on the instance of the single violation condition, the second circuitry is to throttle an execution of instructions with the one of the multiple cores, wherein the second circuitry is to throttle the execution while the multiple cores is maintained in a first power state.

In one or more second embodiments, further to the first embodiment, the performance constraint comprises a threshold maximum variance of a performance metric from a target value.

In one or more third embodiments, further to the first embodiment or the second embodiment, the threshold limit is a threshold maximum dynamic capacitance level.

In one or more fourth embodiments, further to any of the first through third embodiments, the second circuitry to throttle the execution of instructions comprises the second circuitry to provide a bubble in an instruction pipeline of the one core of the multiple cores.

In one or more fifth embodiments, further to any of the first through third embodiments, the second circuitry to throttle the execution of instructions comprises the second circuitry to signal the one core of the multiple cores to squash pulses of the first clock signal to generate a modified version of the first clock signal.

In one or more sixth embodiments, further to any of the first through third embodiments, the second circuitry to throttle the execution of instructions comprises the second circuitry to signal the one core of the multiple cores to stretch pulses of the first clock signal to generate a modified version of the first clock signal.

In one or more seventh embodiments, further to any of the first through third embodiments, the second circuitry to throttle the execution of instructions comprises the second circuitry to signal the one core of the multiple cores to slow an instruction fetch unit of the one core of the multiple cores.

In one or more eighth embodiments, further to any of the first through third embodiments, the multiple indications are first indications, and wherein the first circuitry is further to receive second indications each from a different respective one of the multiple cores, wherein, for each core of the multiple cores, a respective one of the second indications identifies whether the core violates the current test criteria which is based on the threshold limit, based on each of the second indications, detect an instance of a multiple violation condition wherein two or more of the multiple cores each violates the current test criteria, and based on the instance of the multiple violation condition, cause the multiple cores to transition from the first power state to a second power state.

In one or more ninth embodiments, further to any of the first through third embodiments, the processor module is a first processor module, the multiple cores is a first multiple cores, the processor further comprises a second processor module which comprises a second multiple cores, each of the second multiple cores receives a second supply voltage, and wherein each of the second multiple cores receives a second clock signal, and the second multiple cores are to be maintained in a second power state while the execution of instructions with the one of the multiple cores is throttled.

In one or more tenth embodiments, one or more non-transitory computer-readable storage media have stored thereon instructions which, when executed by one or more processing units, cause the one or more processing units to perform a method comprising identifying a threshold limit based on an indication of a performance constraint, providing the threshold limit to each of multiple cores of a processor module, wherein each of the multiple cores receives a first supply voltage, and wherein each of the multiple cores receives a first clock signal, receiving multiple indications each from a different respective one of the multiple cores, wherein, for each core of the multiple cores, a respective one of the multiple indications identifies whether the core violates a current test criteria which is based on the threshold limit, based on each of the multiple indications, detecting an instance of a single violation condition wherein one core of the multiple cores violates the current test criteria, while each other core of the multiple cores satisfies the current test criteria, and based on the instance of the single violation condition, throttling an execution of instructions with the one of the multiple cores, wherein the multiple cores is maintained in a first power state from before the throttling to after the throttling.

In one or more eleventh embodiments, further to the tenth embodiment, the performance constraint comprises a threshold maximum variance of a performance metric from a target value.

In one or more twelfth embodiments, further to the tenth embodiment or the eleventh embodiment, the threshold limit is a threshold maximum dynamic capacitance level.

In one or more thirteenth embodiments, further to any of the tenth through twelfth embodiments, the throttling the execution of instructions comprises providing a bubble in an instruction pipeline of the one core of the multiple cores.

In one or more fourteenth embodiments, further to any of the tenth through twelfth embodiments, the throttling the execution of instructions comprises, at the one core of the multiple cores, squashing pulses of the first clock signal to generate a modified version of the first clock signal.

In one or more fifteenth embodiments, further to any of the tenth through twelfth embodiments, the throttling the execution of instructions comprises, at the one core of the multiple cores, stretching pulses of the first clock signal to generate a modified version of the first clock signal.

In one or more sixteenth embodiments, further to any of the tenth through twelfth embodiments, the throttling the execution of instructions comprises slowing an instruction fetch unit of the one core of the multiple cores.

In one or more seventeenth embodiments, further to any of the tenth through twelfth embodiments, the multiple indications are first indications, the method further comprises receiving second indications each from a different respective one of the multiple cores, wherein, for each core of the multiple cores, a respective one of the second indications identifies whether the core violates the current test criteria which is based on the threshold limit, based on each of the second indications, detecting an instance of a multiple violation condition wherein two or more of the multiple cores each violates the current test criteria, and based on the instance of the multiple violation condition, causing the multiple cores to transition from the first power state to a second power state.

In one or more eighteenth embodiments, further to any of the tenth through twelfth embodiments, the processor module is a first processor module, the multiple cores is a first multiple cores, the processor further comprises a second processor module which comprises a second multiple cores, each of the second multiple cores receives a second supply voltage, and wherein each of the second multiple cores receives a second clock signal, and the second multiple cores is maintained in a second power state from before the throttling to after the throttling.

In one or more nineteenth embodiments, a system comprises a memory to store multiple instructions which are to be executed in a sequence, a processor coupled to the memory, the processor comprising first circuitry to identify a threshold limit based on an indication of a performance constraint, provide the threshold limit to each of multiple cores of a processor module, wherein each of the multiple cores is to receive a first supply voltage, and wherein each of the multiple cores is to receive a first clock signal, receive multiple indications each from a different respective one of the multiple cores, wherein, for each core of the multiple cores, a respective one of the multiple indications identifies whether the core violates a current test criteria which is based on the threshold limit, and based on each of the multiple indications, detect an instance of a single violation condition wherein one core of the multiple cores violates the current test criteria, while each other core of the multiple cores satisfies the current test criteria, and second circuitry coupled to the first circuitry, wherein, based on the instance of the single violation condition, the second circuitry is to throttle an execution of instructions with the one of the multiple cores, wherein the second circuitry is to throttle the execution while the multiple cores is maintained in a first power state.

In one or more twentieth embodiments, further to the nineteenth embodiment, the performance constraint comprises a threshold maximum variance of a performance metric from a target value.

In one or more twenty-first embodiments, further to the nineteenth embodiment or the twentieth embodiment, the threshold limit is a threshold maximum dynamic capacitance level.

In one or more twenty-second embodiments, further to any of the nineteenth through twenty-first embodiments, the second circuitry to throttle the execution of instructions comprises the second circuitry to provide a bubble in an instruction pipeline of the one core of the multiple cores.

In one or more twenty-third embodiments, further to any of the nineteenth through twenty-first embodiments, the second circuitry to throttle the execution of instructions comprises the second circuitry to signal the one core of the multiple cores to squash pulses of the first clock signal to generate a modified version of the first clock signal.

In one or more twenty-fourth embodiments, further to any of the nineteenth through twenty-first embodiments, the second circuitry to throttle the execution of instructions comprises the second circuitry to signal the one core of the multiple cores to stretch pulses of the first clock signal to generate a modified version of the first clock signal.

In one or more twenty-fifth embodiments, further to any of the nineteenth through twenty-first embodiments, the second circuitry to throttle the execution of instructions comprises the second circuitry to signal the one core of the multiple cores to slow an instruction fetch unit of the one core of the multiple cores.

In one or more twenty-sixth embodiments, further to any of the nineteenth through twenty-first embodiments, the multiple indications are first indications, and wherein the first circuitry is further to receive second indications each from a different respective one of the multiple cores, wherein, for each core of the multiple cores, a respective one of the second indications identifies whether the core violates the current test criteria which is based on the threshold limit, based on each of the second indications, detect an instance of a multiple violation condition wherein two or more of the multiple cores each violates the current test criteria, and based on the instance of the multiple violation condition, cause the multiple cores to transition from the first power state to a second power state.

In one or more twenty-seventh embodiments, further to any of the nineteenth through twenty-first embodiments, the processor module is a first processor module, the multiple cores is a first multiple cores, the processor further comprises a second processor module which comprises a second multiple cores, each of the second multiple cores receives a second supply voltage, and wherein each of the second multiple cores receives a second clock signal, and the second multiple cores are to be maintained in a second power state while the execution of instructions with the one of the multiple cores is throttled.

In one or more twenty-eighth embodiments, a method at a processor comprises identifying a threshold limit based on an indication of a performance constraint, providing the threshold limit to each of multiple cores of a processor module, wherein each of the multiple cores receives a first supply voltage, and wherein each of the multiple cores receives a first clock signal, receiving multiple indications each from a different respective one of the multiple cores, wherein, for each core of the multiple cores, a respective one of the multiple indications identifies whether the core violates a current test criteria which is based on the threshold limit, based on each of the multiple indications, detecting an instance of a single violation condition wherein one core of the multiple cores violates the current test criteria, while each other core of the multiple cores satisfies the current test criteria, and based on the instance of the single violation condition, throttling an execution of instructions with the one of the multiple cores, wherein the multiple cores is maintained in a first power state from before the throttling to after the throttling.

In one or more twenty-ninth embodiments, further to the twenty-eighth embodiment, the performance constraint comprises a threshold maximum variance of a performance metric from a target value.

In one or more thirtieth embodiments, further to the twenty-eighth embodiment or the twenty-ninth embodiment, the threshold limit is a threshold maximum dynamic capacitance level.

In one or more thirty-first embodiments, further to any of the twenty-eighth through thirtieth embodiments, the throttling the execution of instructions comprises providing a bubble in an instruction pipeline of the one core of the multiple cores.

In one or more thirty-second embodiments, further to any of the twenty-eighth through thirtieth embodiments, the throttling the execution of instructions comprises, at the one core of the multiple cores, squashing pulses of the first clock signal to generate a modified version of the first clock signal.

In one or more thirty-third embodiments, further to any of the twenty-eighth through thirtieth embodiments, the throttling the execution of instructions comprises, at the one core of the multiple cores, stretching pulses of the first clock signal to generate a modified version of the first clock signal.

In one or more thirty-fourth embodiments, further to any of the twenty-eighth through thirtieth embodiments, the throttling the execution of instructions comprises slowing an instruction fetch unit of the one core of the multiple cores.

In one or more thirty-fifth embodiments, further to any of the twenty-eighth through thirtieth embodiments, the multiple indications are first indications, the method further comprises receiving second indications each from a different respective one of the multiple cores, wherein, for each core of the multiple cores, a respective one of the second indications identifies whether the core violates the current test criteria which is based on the threshold limit, based on each of the second indications, detecting an instance of a multiple violation condition wherein two or more of the multiple cores each violates the current test criteria, and based on the instance of the multiple violation condition, causing the multiple cores to transition from the first power state to a second power state.

In one or more thirty-sixth embodiments, further to any of the twenty-eighth through thirtieth embodiments, the processor module is a first processor module, the multiple cores is a first multiple cores, the processor further comprises a second processor module which comprises a second multiple cores, each of the second multiple cores receives a second supply voltage, and wherein each of the second multiple cores receives a second clock signal, and the second multiple cores is maintained in a second power state from before the throttling to after the throttling.

Techniques and architectures for determining an operation of a processor are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
first circuitry to:
identify a threshold limit based on an indication of a performance constraint;
provide the threshold limit to each of multiple cores of a processor module, wherein each of the multiple cores is to receive a first supply voltage, and wherein each of the multiple cores is to receive a first clock signal;
receive multiple indications each from a different respective one of the multiple cores, wherein, for each core of the multiple cores, a respective one of the multiple indications identifies whether the core violates a current test criteria which is based on the threshold limit; and
based on each of the multiple indications, detect an instance of a single violation condition wherein one core of the multiple cores violates the current test criteria, while each other core of the multiple cores satisfies the current test criteria; and
second circuitry coupled to the first circuitry, wherein, based on the instance of the single violation condition, the second circuitry is to throttle an execution of instructions with the one of the multiple cores, wherein the second circuitry is to throttle the execution while the multiple cores is maintained in a first power state.

2. The processor of claim 1, wherein the performance constraint comprises a threshold maximum variance of a performance metric from a target value.

3. The processor of claim 1, wherein the threshold limit is a threshold maximum dynamic capacitance level.

4. The processor of claim 1, wherein the second circuitry to throttle the execution of instructions comprises the second circuitry to provide a bubble in an instruction pipeline of the one core of the multiple cores.

5. The processor of claim 1, wherein the second circuitry to throttle the execution of instructions comprises the second circuitry to signal the one core of the multiple cores to squash pulses of the first clock signal to generate a modified version of the first clock signal.

6. The processor of claim 1, wherein the second circuitry to throttle the execution of instructions comprises the second circuitry to signal the one core of the multiple cores to stretch pulses of the first clock signal to generate a modified version of the first clock signal.

7. The processor of claim 1, wherein the second circuitry to throttle the execution of instructions comprises the second circuitry to signal the one core of the multiple cores to slow an instruction fetch unit of the one core of the multiple cores.

8. The processor of claim 1, wherein the multiple indications are first indications, and wherein the first circuitry is further to:
receive second indications each from a different respective one of the multiple cores, wherein, for each core of the multiple cores, a respective one of the second indications identifies whether the core violates the current test criteria which is based on the threshold limit;
based on each of the second indications, detect an instance of a multiple violation condition wherein two or more of the multiple cores each violates the current test criteria; and
based on the instance of the multiple violation condition, cause the multiple cores to transition from the first power state to a second power state.

9. The processor of claim 1, wherein:
the processor module is a first processor module;
the multiple cores is a first multiple cores;
the processor further comprises a second processor module which comprises a second multiple cores;
each of the second multiple cores receives a second supply voltage, and wherein each of the second multiple cores receives a second clock signal; and
the second multiple cores are to be maintained in a second power state while the execution of instructions with the one of the multiple cores is throttled.

10. One or more non-transitory computer-readable storage media having stored thereon instructions which, when executed by one or more processing units, cause the one or more processing units to perform a method comprising:
identifying a threshold limit based on an indication of a performance constraint;
providing the threshold limit to each of multiple cores of a processor module, wherein each of the multiple cores receives a first supply voltage, and wherein each of the multiple cores receives a first clock signal;
receiving multiple indications each from a different respective one of the multiple cores, wherein, for each core of the multiple cores, a respective one of the multiple indications identifies whether the core violates a current test criteria which is based on the threshold limit;
based on each of the multiple indications, detecting an instance of a single violation condition wherein one core of the multiple cores violates the current test criteria, while each other core of the multiple cores satisfies the current test criteria; and
based on the instance of the single violation condition, throttling an execution of instructions with the one of the multiple cores, wherein the multiple cores is maintained in a first power state from before the throttling to after the throttling.

11. The one or more computer-readable storage media of claim 10, wherein the performance constraint comprises a threshold maximum variance of a performance metric from a target value.

12. The one or more computer-readable storage media of claim 10, wherein the threshold limit is a threshold maximum dynamic capacitance level.

13. The one or more computer-readable storage media of claim 10, wherein the throttling the execution of instructions comprises providing a bubble in an instruction pipeline of the one core of the multiple cores.

14. The one or more computer-readable storage media of claim 10, wherein the throttling the execution of instructions comprises slowing an instruction fetch unit of the one core of the multiple cores.

15. The one or more computer-readable storage media of claim 10, wherein the multiple indications are first indications, the method further comprising:
receiving second indications each from a different respective one of the multiple cores, wherein, for each core of the multiple cores, a respective one of the second indications identifies whether the core violates the current test criteria which is based on the threshold limit;
based on each of the second indications, detecting an instance of a multiple violation condition wherein two or more of the multiple cores each violates the current test criteria; and
based on the instance of the multiple violation condition, causing the multiple cores to transition from the first power state to a second power state.

16. A system comprising:
a memory to store multiple instructions which are to be executed in a sequence;
a processor coupled to the memory, the processor comprising:
first circuitry to:
identify a threshold limit based on an indication of a performance constraint;
provide the threshold limit to each of multiple cores of a processor module, wherein each of the multiple cores is to receive a first supply voltage, and wherein each of the multiple cores is to receive a first clock signal;
receive multiple indications each from a different respective one of the multiple cores, wherein, for each core of the multiple cores, a respective one of the multiple indications identifies whether the core violates a current test criteria which is based on the threshold limit; and
based on each of the multiple indications, detect an instance of a single violation condition wherein one core of the multiple cores violates the current test criteria, while each other core of the multiple cores satisfies the current test criteria; and
second circuitry coupled to the first circuitry, wherein, based on the instance of the single violation condition, the second circuitry is to throttle an execution of instructions with the one of the multiple cores, wherein the second circuitry is to throttle the execution while the multiple cores is maintained in a first power state.

17. The system of claim 16, wherein the performance constraint comprises a threshold maximum variance of a performance metric from a target value.

18. The system of claim 16, wherein the threshold limit is a threshold maximum dynamic capacitance level.

19. The system of claim 16, wherein the second circuitry to throttle the execution of instructions comprises the second circuitry to provide a bubble in an instruction pipeline of the one core of the multiple cores.

20. The system of claim 16, wherein the second circuitry to throttle the execution of instructions comprises the second circuitry to signal the one core of the multiple cores to slow an instruction fetch unit of the one core of the multiple cores.
